(19) United States
(12) Patent Application Publication
(10) Pub. No.: US 2021/0375256 A1
(43) Pub. Date: Dec. 2, 2021

(54) SIGNAL PROCESSING DEVICE AND METHOD, AND PROGRAM

(71) Applicant: SONY CORPORATION, TOKYO (JP)

(72) Inventors: NAOKI MURATA, TOKYO (JP); YUHKI MITSUFUJI, TOKYO (JP); YU MAENO, TOKYO (JP); JIHUI ZHANG, TOKYO (JP)

(21) Appl. No.: 17/286,121

(22) PCT Filed: Oct. 11, 2019
(86) PCT No.: PCT/JP2019/040183

§ 371 Date: Apr. 16, 2021

(30) Foreign Application Priority Data
Oct. 25, 2018 (JP) 2018-200618

(51) Int. Cl. G10K 11/178

(52) U.S. Cl. CPC G10K 11/17854; G10K 11/17857; G10K 2210/3219; G10K 2210/3028; G10K 2210/3215; G10K 11/17881

(57) ABSTRACT

The present technology relates to signal processing device and method, and a program for enabling spatial noise cancelling with a saved space and a small computation amount. The signal processing device includes a control section that, on the basis of a first microphone signal obtained by sound collection at a first microphone array, a speaker drive signal of an output sound for cancelling a sound which is propagated from an outside of a predetermined region to the predetermined region and is collected by the first microphone array, and that outputs the output sound from a speaker array on the basis of the speaker drive signal. The first microphone array includes a plurality of microphones. The speaker array includes at least one high-order speaker. The present technology is applicable to a signal processing device.

### TECHNICAL FIELD

The present technology relates to signal processing device and method, and a program, and particularly, relates to signal processing device and method, and a program in which spatial noise cancelling can be performed with a saved space and a small computation amount.

### BACKGROUND ART

In the past, spatial noise cancelling in which noise cancelling is performed in a target domain by means of a speaker array that is formed by arranging a plurality of arranged speakers has been known.

As a technology pertaining to such spatial noise cancelling, a technology of reducing a computation amount through wavenumber-domain signal processing, for example, has been proposed (for example, see NPL 1). In this technology, a speaker array including a plurality of speakers having a single directivity is used to perform spatial noise cancelling.

### CITATION LIST

### Non Patent Literature

### [NPL 1]

J. Zhang, T. D. Abhayapala, W. Zhang, P. N. Samarasinghe, and S. Jiang. Active noise control over space: A wave domain approach. IEEE/ACM Transactions on Audio, Speech and Language Processing (TASLP), 26(4):774-786, 2018.

### SUMMARY

### Technical Problem

However, the abovementioned technology has a difficulty in performing spatial noise cancelling that exhibits sufficiently high performance with a saved space and a small computation amount.

For example, in the technology disclosed in NPL 1, the computation amount can be reduced but a wide space to dispose a speaker array is needed because an increase of the number of speakers included in the speaker array is necessary to sufficiently cancel noise sounds.

The present technology has been made in view of such a circumstance and is provided to enable spatial noise cancelling with a saved space and a small computation amount.

### Solution to Problem

A signal processing device according to one aspect of the present technology includes a control section that generates, on the basis of a first microphone signal obtained by sound collection at a first microphone array, a speaker drive signal of an output sound for cancelling a sound which is propagated from an outside of a predetermined region to the predetermined region and is collected by the first microphone array, and that outputs the output sound from a speaker array on the basis of the speaker drive signal, the first microphone array including a plurality of microphones, the speaker array including at least one high-order speaker.

A signal processing method or a program according to one aspect of the present technology includes the steps of generating, on the basis of a microphone signal obtained by sound collection at a microphone array including a plurality of microphones, a speaker drive signal of an output sound for cancelling a sound which is propagated from an outside of a predetermined region to the predetermined region and is collected by the microphone array, and outputting, on the basis of the speaker drive signal, the output sound from a speaker array including at least one high-order speaker.

According to the one aspect of the present technology, a speaker drive signal of an output sound for cancelling a sound which is propagated from the outside of the predetermined region to the predetermined region and is collected by the first microphone array is generated, on the basis of the first microphone signal obtained by sound collection at the first microphone array including a plurality of microphones, and the output sound is outputted from the speaker array including at least one high-order speaker, on the basis of the speaker drive signal.

### BRIEF DESCRIPTION OF DRAWINGS

FIG. 1 is a diagram depicting arrangement of an error microphone array, a high-order speaker array, and a reference microphone array.

FIG. 2 is an explanatory diagram of a global mode coefficient and a local mode coefficient.

FIG. 3 is a diagram depicting a configuration of a MIMO spatial noise cancelling system.

FIG. 4 is a diagram depicting a configuration of an MD-GM spatial noise cancelling system.

FIG. 5 is a flowchart for explaining a spatial noise cancelling process.

FIG. 6 is a diagram depicting a configuration of an MD-LM spatial noise cancelling system.

FIG. 7 is a flowchart for explaining a spatial noise cancelling process.

FIG. 8 is an explanatory diagram of a computation amount of a filtering process.

FIG. 9 is an explanatory diagram of a computation amount of a filter coefficient updating process.

FIG. 10 is a diagram depicting a configuration example of a computer.

### DESCRIPTION OF EMBODIMENTS

Hereinafter, embodiments to which the present technology is applied will be explained with reference to the drawings.

### First Embodiment

### <Spatial Noise Cancelling System>

In the present technology, high-order speakers are used, and computation of updating a filter coefficient and computation of performing filtering are performed in terms of a wavenumber domain, that is, a mode domain. Accordingly, spatial noise cancelling can be performed with a saved space and a small computation amount.

For example, in a case where a high-order speaker is used as a speaker, spatial noise cancelling can be performed with a space saved much, compared to a case where a normal speaker that can reproduce a single directivity only is used. In addition, in the present technology, since at least update of a filter coefficient is achieved by computation in a wavenumber domain, the computation amount can be reduced. The high-order speaker includes a plurality of speakers. Therefore, a computation process in a wavenumber domain in the case where a normal speaker is used cannot be applied directly to a computation process in the case where a high-order speaker is used. To this end, the present technology enables computation in a wavenumber domain even in a case where a high-order speaker is used.

First, the present technology will be explained. For simplification, the following explanation is regarding spatial noise cancelling for a two-dimensional sound field. However, noise cancelling for a three-dimensional sound field can be performed in a similar manner to that for a two-dimensional sound field. Spatial noise cancelling for a two-dimensional sound field can be extended easily to spatial noise cancelling for a three-dimensional sound field.

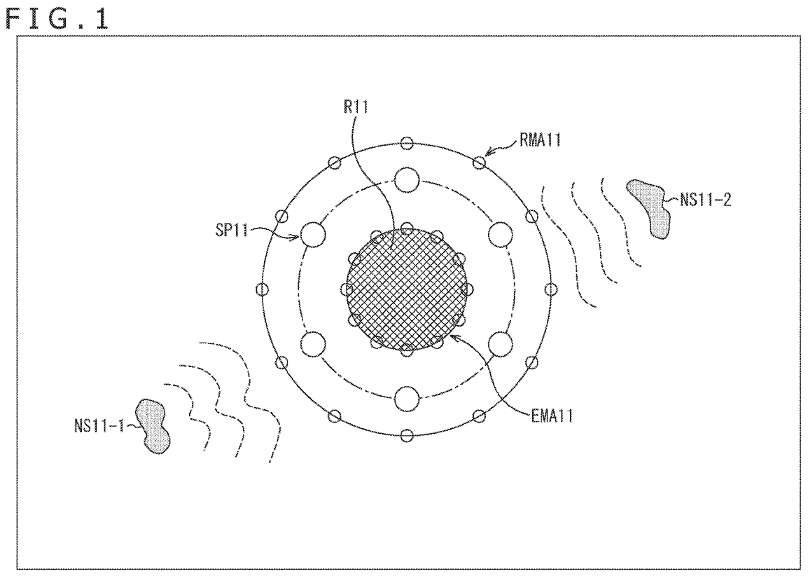

The explanation will be given on the assumption that, in the present technology, an error microphone array EMA11, a high-order speaker array SP11, and a reference microphone array RMA11 are arranged, as depicted in FIG. 1.

It is to be noted that arrangement of the error microphone array, the high-order speaker array, and the reference microphone array in the present technology is not limited to the arrangement depicted in FIG. 1. Any arrangement can be adopted therefor as long as the high-order speaker array is placed between the error microphone array and the reference microphone array.

In addition, each of the error microphone array and the reference microphone array is not limited to a ring-like microphone array. Any microphone array such as a combination of linear microphone arrays or a spherical microphone array can be adopted. Likewise, the high-order speaker array is not limited to a ring-like array. An array of any shape such as a rectangular shape or a spherical shape can be adopted.

In the example depicted in FIG. 1, a spatial noise cancelling system is configured with the error microphone array EMA11, the high-order speaker array SP11, and the reference microphone array RMA11 arranged in a two-dimensional space.

In this example, a circular target region R11 which is located in the center in FIG. 1 is a target region of spatial noise cancelling. For example, in the target region R11, a sound is outputted from the high-order speaker array SP11 such that a sound (hereinafter, also referred to as spatial noise sound) that is propagated from a noise source NS11-1 and a noise source NS11-2, which are located outside the target region R11, to the target region R11 become inaudible. That is, the spatial noise sound is cancelled by the sound outputted from the high-order speaker array SP11.

It is to be noted that, hereinafter, the noise source NS11-1 and the noise source NS11-2 are also referred to as noise sources NS11 simply, unless it is necessary to specifically distinguish from each other.

The error microphone array EMA11 is a ring-like microphone array including a plurality of microphone that is arranged into a ring-like shape to surround the target region R11, and is used to monitor whether a spatial noise sound in the target region R11 is cancelled sufficiently. It is to be noted that the error microphone array EMA11 may be disposed inside the target region R11.

Further, the high-order speaker array SP11 including a plurality of high-order speakers that is arranged into a ring-like shape to surround the error microphone array EMA11 is disposed on the outer side than the error microphone array EMA11. Here, the high-order speaker array SP11 is a ring-like speaker array.

The high-order speakers constituting the high-order speaker array SP11 are realized by a speaker array that is obtained by arranging a plurality of speakers into a ring-like or a spherical shape and that has freely-controllable directivities, for example. In other words, the high-order speakers can reproduce a plurality of any directivities, that is, a plurality of any radiation patterns.

Here, a high-order speaker is assumed to be able to reproduce a first or more order radiation pattern (directivity). The order of a radiation pattern is the index of a base of a harmonic function, that is, a ring-like harmonic function, in this case. It is to be noted that, in a case where the high-order speaker array is a spherical speaker array, the index of a base of a spherical surface harmonic function corresponds to the order of the radiation pattern. Hereinafter, the speakers constituting a high-order speaker are also referred to as drivers. In addition, multipole sound sources may be used in place of the high-order speakers, or a speaker array including one high-order speaker may be used in place of the high-order speaker array SP11.

It is known that a space for installing the high-order speaker array SP11 including the high-order speakers described above can be made smaller than a space for a speaker array including normal speakers which can reproduce a single directivity only. Therefore, when the high-order speaker array SP11 is used, spatial noise cancelling can be performed with a saved space.

Further, in FIG. 1, the reference microphone array RMA11 including a plurality of microphones that is arranged into a ring-like shape to surround the outer side of the high-order speaker array SP11 is disposed. That is, in FIG. 1, the error microphone array EMA11 is disposed opposite to the reference microphone array RMA11 with respect to the high-order speaker array SP11.

Here, the reference microphone array RMA11 is a ring-like microphone array and is used to collect ambient sounds including a spatial noise sound and to surmise whether a wavefront of a spatial noise sound is generated in the target region R11.

In the spatial noise cancelling system thus formed, a filter coefficient for spatial noise cancelling is generated (updated) on the basis of a reference microphone signal obtained by sound collection at the reference microphone array RMA11 and an error microphone signal obtained by sound collection at the error microphone array EMA11.

Then, with use of the generated filter coefficient, filtering of the reference microphone signal is performed to generate a speaker drive signal, and the high-order speaker array SP11 outputs a sound on the basis of the speaker drive signal. As a result, a noise sound in the target region R11, that is, a spatial noise sound from the noise source NS11 is lessened (cancelled).

It is to be noted that the high-order speaker array SP11 may be disposed so as to surround the outer side of the reference microphone array RMA11, and the error microphone array EMA11 may be disposed so as to surround the outer side of the high-order speaker array SP11. In such a case, a target region to be subjected to spatial noise cancelling is a region outside the error microphone array EMA11, that is, a region on a side opposite to the high-order speaker array SP11.

In the following explanation, the number of microphones constituting the reference microphone array RMA11 is defined as Nᵣ, the number of microphones constituting the error microphone array EMA11 is defined as Nₑ, and the number of high-order speakers constituting the high-order speaker array SP11 is defined as Nₗ.

In addition, it is assumed that each of the high-order speakers constituting the high-order speaker array SP11 includes Q drivers. Therefore, the number of drivers constituting the high-order speaker array SP11 is QNₗ.

Further, hereinafter, a reference microphone signal is also represented by x(k), and an error microphone signal is also represented by e(k).

A reference microphone signal x(k) is a complex vector of a certain wavenumber k. This complex vector has, as elements, signals individually obtained by the Nᵣ microphones constituting the reference microphone array RMA11.

Likewise, an error microphone signal e(k) is a complex vector of a certain wavenumber k. This complex vector has, as elements, signals individually obtained by the Nₑ microphones constituting the error microphone array EMA11.

The wavenumber k is defined by k=2πf/c [1/m] in which f[Hz] represents a time-frequency variable, and c [m/s] represents a sound velocity.

In addition, a drive signal that is a complex vector of Q×1 for the n_l-th high-order speaker of the Nₗ high-order speakers constituting the high-order speaker array SP11 is defined as y_{n_l}(k)=[y_{n_l,1}(k), . . . , y_{n_l,Q}(k)]^{T}. Further, a complex vector of QNₗ×1 that is obtained by arranging the Nₗ drive signals y_{n_l}(k), as indicated by Expression (1), is defined as y(k). The vector y(k) represents a speaker drive signal for the high-order speaker array SP11.

[Math. 1]

y(k)=[y₁(k)^{T}, . . . ,y_{N}_{ₗ}(k)^{T}]^{T} (1)

It is to be noted that, hereinafter, k which represents a wavenumber may be omitted for convenience of expression.

### <Global Mode Coefficient>

Next, mode coefficients for the reference microphone array RMA11 and the error microphone array EMA11 will be explained.

In the sound field space control technologies including spatial noise cancelling, many methods for performing control after transforming a spatial sound pressure distribution into a domain which is a mode domain, that is, a wavenumber domain, instead of controlling sound pressures at multiple points, have been proposed.

A mode domain signal is called a mode coefficient. Transformation of a sound pressure distribution to a mode coefficient corresponds to development of a wave motion in a space by using the bases of multiple wave motions. This process is similar to Fourier transformation in which a time signal is developed with use of sine waves of multiple frequencies.

An explanation will be given of transformation of an error microphone signal e(k) observed by the error microphone array EMA11 into a mode coefficient by way of example. It is to be noted that an explanation of transformation of a reference microphone signal x(k) observed by the reference microphone array RMA11 into a mode coefficient is omitted because this transformation is similar to that of the error microphone signal e(k) which will be explained below.

For example, a signal, that is, a sound pressure observed by an n_e-th microphone of the Nₑ microphones constituting the error microphone array EMA11 is defined as p_{n_e}. A complex vector of Nₑ×1 that is obtained by arranging the sound pressures p_{n_e}, as indicated by Expression (2), is defined as p. It is to be noted that the complex vector p is the error microphone signal e(k).

[Math. 2]

p=[p₁, . . . ,p_{N}_{ₑ}]^{T} (2)

A mode coefficient p′ that is obtained by transforming the complex vector p to a mode domain signal can be obtained as follows. The mode coefficient p′ is a complex vector of (2M_{g}+1)×1 and is defined as p′=[p_{-Mg}, . . . , p_{Mg}]^{T}.

When an imaginary number is defined as j and the radius of the error microphone array EMA11 is defined as Rₑ, the elements of the mode coefficient p′ can be obtained by Expression (3). In Expression (3), m_g=−M_{g}, . . . , M_{g} is satisfied, and M_{g} represents a maximum order number of the mode, that is, a maximum order number of a global mode coefficient which will be explained later.

$$\begin{matrix}[ Math . 3 ] & \\ {p}_{m\_g} = \frac{1}{{N}_{e} {J}_{\_ ( m\_g )} ( {kR}_{e} )} {\sum }_{n\_e = 1}^{{N}_{e}} {P}_{n\_e} {e}^{2 π j ( m\_g ) ( ( n\_e ) - 1 ) / {N}_{e}} & ( 3 )\end{matrix}$$

It is to be noted that, in Expression (3), J__{(m_g)}(⋅) represents a Bessel function of the first kind of the (m_g) order. In addition, a transformation indicated by Expression (3) is described in detail in “M. A. Poletti. A unified theory of horizontal holographic sound systems. Journal of the audio Engineering Society, 48(12): 1155-1182, 2000.” for example.

In addition, a transformation to a mode coefficient in a three-dimensional sound field is described in detail in “M. A. Poletti. Three-dimensional surround sound systems based on spherical harmonics. Journal of the Audio Engineering Society, 53(11):1004-1025, 2005.” for example.

Such a transformation based on Expression (3) is a linear transformation. Thus, Expression (3) can be written by a matrix form, as expressed in Expression (4) using a predetermined transformation matrix T_{ge} of (2M_{g}+1)×Nₑ.

[Math. 4]

p′=T_{ge}p (4)

When (⋅)m,n represents an element (m,n) of a matrix, an element of the transformation matrix T_{ge} is indicated by Expression (5).

[Math. 5]

(T_{ge})_{(m_g),(n_e)}=e^{2πj(m_g)((n_e)-1)/N}^{ₑ}/NₑJ__{(m_g)}(kRₑ) (5)

The mode coefficient p′ obtained by Expression (4) is a mode coefficient the origin of which is a predetermined reference position in a space, that is, which is based on the origin of a global coordinate system. Hereinafter, such a mode coefficient is also referred to as global mode coefficient, in particular.

In addition, also for the reference microphone signal x(k) of the reference microphone array RMA11, a global mode coefficient can be obtained by computation similar to that by Expression (4). Hereinafter, a transformation matrix for transforming the reference microphone signal x(k) to a global mode coefficient is expressed by T_{gr}.

### <Local Mode Coefficient>

Next, a local mode coefficient for a high-order speaker will be explained. In particular, hereinafter, a mode coefficient the criteria (origin) of which is the position of a high-order speaker and which is for the high-order speaker, is also referred to as local mode coefficient. The local mode coefficient refers to a mode coefficient the origin of which is a position different from the origin of a global mode coefficient.

For example, in a two-dimensional space, a sound field p(R_ₒ) that a high-order speaker forms at a position R_ₒ=(r_ₒ, φ_ₒ) which is indicated by a polar coordinate formed by a radius r_ₒ and an angle φ_ₒ, can be indicated by Expression (6).

$$\begin{matrix}[ Math . 6 ] & \\ p ( R\_o ) = {\sum }_{m\_l = - {M}_{l}}^{{M}_{l}} {β}_{\_ ( m\_l )} {H}_{\_ ( m\_l )} ( {Ka}_{\_ ( n \_l , o )} ) {e}^{- j ( m\_l ) θ\_ ( n \_l , o )} & ( 6 )\end{matrix}$$

In Expression (6), H__{(m_l)}(ka__{(n_l,o)})e^{-j(m_l)θ_(n_l,o)} represents each of different radiation patterns of the high-order speaker. The radiation patterns are called mode. In addition, in Expression (6), β__{(m_l)} represents the intensity of the amplitude of a mode corresponding to m_l, and β__{(m_l)} represents a local mode coefficient for the high-order speaker. Further, Mₗ represents a maximum local mode order, that is, the maximum order number of the local mode coefficient. Further, in Expression (6), a__{(n_l,o)} represents the distance from the position of the high-order speaker to the position R_ₒ, and θ__{(n_l,o)} represents the angle formed between a vector the starting point of which is the position of the high-order speaker and the ending point of which is the position R_ₒ and a vector the starting point of which is the position of the high-order speaker and the ending point of which is the origin of the global coordinate system.

As seen from Expression (6), the sound field p(R_ₒ) formed by one high-order speaker is a combination of a plurality of radiation patterns.

Therefore, the local mode coefficient β__{(m_l)} for each mode is properly determined (controlled) to output sounds from the high-order speaker so that the sounds having various directivities can be outputted. That is, any directivities can be formed (reproduced).

Here, a drive signal for the Q drivers constituting the n_l-th high-order speaker of the Nₗ high-order speakers constituting the high-order speaker array SP11 is defined as y_{n_l}. Here, in y_{n_l}, the wavenumber k in the drive signal y_{n_l}(k) which is the complex vector of Q×1 described above is omitted.

Here, the local mode coefficient β__{(n_l)} obtained for the Q drivers is a complex vector of (2Mₗ+1)×1 and can be written in a matrix form, as indicated by Expression (7).

[Math. 7]

β__{(n_l)}=Tₗₛy_{n_l} (7)

In Expression (7), Tₗₛ which is a matrix of (2Mₗ+1)×Q, is a transformation matrix for transforming the drive signal y_{n_l} to the local mode coefficient β__{(n_l)}. It is noted that the transformation matrix Tₗₛ may be analytically obtained or may be obtained through measurement.

### <Mutual Transformation Between Global Mode Coefficient and Local Mode Coefficient>

Further, a mutual transformation between a global mode coefficient and a local mode coefficient will be explained.

As explained above, the plurality of drivers of the high-order speaker that is driven independently form a directivity expressed by the local mode coefficient. Here, it is important that each of these local mode coefficients depends on the origin of the high-order speaker.

Meanwhile, in sound field control involving spatial noise cancelling, a certain specific target region is focused in many cases. Therefore, in a case where sound field control in such a region is taken in terms of a mode domain, a certain origin is set, and a mode coefficient that depends on the origin is controlled. In this case, a mode coefficient the origin of which is a position different from the position of a high-order speaker, that is, the origin of the high-order speaker, is the abovementioned global mode coefficient.

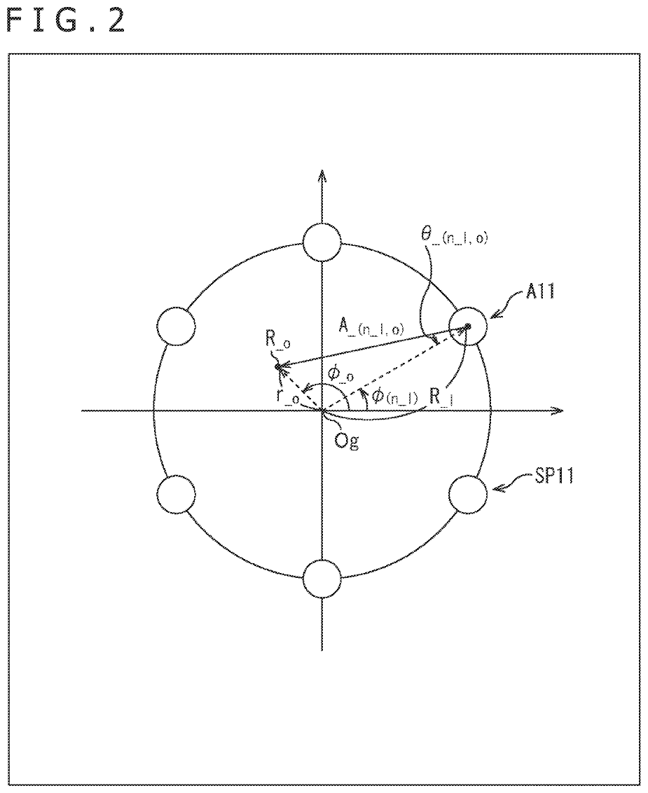

Here, for example, it is assumed that the Nₗ high-order speakers constituting the high-order speaker array SP11 are arranged at equal interval on a circumference having a radius R_ₗ and being centered on a predetermined origin Og, as depicted in FIG. 2. It is to be noted that the components in FIG. 2 corresponding to those in FIG. 1 are denoted by the same reference signs, and an explanation thereof will be omitted.

In FIG. 2, the N₁ high-order speakers constituting the high-order speaker array SP11 are arranged into a ring-like shape centered on the origin Og. For example, a circle denoted by an arrow A11 represents the n_l-th high-order speaker included in the high-order speaker array SP11.

Here, the position of the n_l-th high-order speaker is expressed by (R_ₗ, φ_{(n_l)}) in a polar coordinate using a radius R_ₗ which is the distance from the origin Og and an angle φ_{(n_l)} with respect to a predetermined axis. In addition, when a vector the starting point of which is the position of the high-order speaker and the ending point of which is the position R_ₒ is defined as vector A__{(n_l,o)}, a__{(n_l,o)} in Expression (6) represents the length (magnitude) of the vector A__{(n_l,o)}, and θ__{(n_l,o)} in Expression (6) represents the angle formed between a vector the starting point of which is the position of the high-order speaker and the ending point of which is the origin Og and the vector A__{(n_l,o)}.

Now, to control the sound field around the origin Og, drive signals for the respective drivers constituting each of the Nₗ high-order speakers are controlled. Accordingly, the local mode coefficients for the respective high-order speakers can be controlled properly, and a desired sound field can be formed.

However, a control target is the sound field around the origin Og. That is, a global mode coefficient the development center of which is the origin Og needs to be controlled. Therefore, a transformation of a local mode coefficient to a global mode coefficient is needed.

Such a transformation of a local mode coefficient to a global mode coefficient is used in sound field control using a high-order speaker, for example.

Here, on the basis of the arrangement of the high-order speakers depicted in FIG. 2, the transformation of a local mode coefficient for each high-order speaker to a global mode coefficient centered on the origin Og will be explained. It is to be noted that arrangement of the high-order speakers constituting the high-order speaker array SP11 according to the present technology is not limited to the example depicted in FIG. 2, and any arrangement may be adopted.

For example, it is assumed that the sound field p(R_ₒ) in the position R_ₒ that is near the origin Or is developed with the origin Og set as the center, as indicated by Expression (8). It is to be noted that the maximum global mode order number of the sound field p(R_ₒ), that is, the maximum order number of the mode is defined as M_{g}.

$$\begin{matrix}[ Math . 8 ] & \\ p ( R\_o ) = {\sum }_{m\_g = - {M}_{g}}^{{M}_{g}} {p}_{\_ ( m\_g )} ( R\_o ) = {\sum }_{m\_g = - {M}_{g}}^{{M}_{g}} {J}_{\_ ( m\_g )} ( kr\_o ) {γ}_{\_ ( m\_g )} {e}^{- j ( m\_g ) {ϕ}_{\_o}} & ( 8 )\end{matrix}$$

In Expression (8), p__{(m_g)}(R_ₒ) represents a component when the sound field p(R_ₒ) is developed for each global mode. In addition, γ__{(m_g)} represents a complex number, and represents a global mode coefficient when the sound field p(R_ₒ) is developed with the origin Og set as the center. Further, m_g represents an index of a global mode.

Here, the sound field p__{(n_l),(m_l)}(R_ₒ) formed by the (m_l) order mode component of a high-order speaker located at the position (R_ₗ, φ_{(n_l)}) can be indicated by Expression (9) in which r_ₒ<R_ₗ.

$$\begin{matrix} [ Math . 9 ] & \\ {p}_{\_ ( n \_l ) , ( m\_l )} ( {R}_{\_ o} ) = {\sum }_{m\_g = - {M}_{g}}^{{M}_{g}} {J}_{\_ ( m\_g )} ( {kr}_{\_ o} ) {H}_{\_ ( ( m\_g ) + ( m \_ l ) )} ( {kR}_{\_ l} ) {e}^{- j ( m\_g ) ( {ϕ}_{\_ o} - {ϕ}_{( n \_ l )} ) ,} {r}_{\_ o} < {R}_{\_l} & ( 9 )\end{matrix}$$

Therefore, when the (m_l) order mode (local mode) coefficient for the n_l-th high-order speaker included in the high-order speaker array SP11 is defined as α__{(n_l),(m_l)}, the sound field p(R_ₒ) to be formed by the entire high-order speaker array SP11 is obtained as indicated by Expression (10). It is to be noted that the local mode coefficient α__{(n_l),(m_l)} corresponds to the local mode coefficient β__{(m_l)} in Expression (6).

$$[ Math . 10 ]$$

$$( 10 )$$

$$\begin{matrix}p ( {R}_{\_o} ) = {\sum }_{n\_l = 1}^{{N}_{l}} {\sum }_{m\_l = - {M}_{l}}^{{M}_{l}} {α}_{\_ ( n\_l ) , ( m\_l )} \\ ( {\sum }_{m\_g = - {M}_{g}}^{{M}_{g}} {J}_{\_ ( m\_g )} ( {kr}_{\_ o} ) {H}_{\_ ( ( m\_g ) + ( m\_l ) )} ( {kR}_{\_ l} ) {e}^{- j ( m\_g ) ( {ϕ}_{\_ o} - {ϕ}_{( n\_l )} )} ) \\ = {\sum }_{m\_g = - {M}_{g}}^{{M}_{g}} {J}_{\_ ( m\_g )} ( {kr}_{\_o} ) \\ ( {\sum }_{n\_l = 1}^{{N}_{l}} {\sum }_{m\_l = - {M}_{l}}^{{M}_{l}} {α}_{\_ ( n\_l ) , ( m\_l )} {H}_{\_ ( ( m\_g ) + ( m\_l ) )} ( {kR}_{\_ l} ) {e}^{j ( m\_g ) {ϕ}_{( n\_l )}} ) {e}^{- j ( m\_g ) {ϕ}_{\_ o}}\end{matrix}$$

On the basis of the above Expression (8) and Expression (10), the relation between the global mode coefficient γ__{(m_g)} and the local mode coefficient α__{(n_l),(m_l)} for each of the Nₗ high-order speakers is indicated by Expression (11).

$$\begin{matrix} [ Math . 11 ] & \\ {γ}_{\_ ( m\_g )} = {\sum }_{n\_l = 1}^{{N}_{l}} {\sum }_{m\_l = - {M}_{l}}^{{M}_{l}} {α}_{\_ ( n\_l ) , ( m\_l )} {H}_{\_ ( ( m\_g ) + ( m\_l ) )} ( {kR}_{\_ l} ) {e}^{j ( m\_g ) {ϕ}_{( n\_l )}} & ( 11 )\end{matrix}$$

In addition, a complex vector of (2M_{g}+1)×1 obtained by arranging the global mode coefficients γ__{(m_g)} is defined as γ, as indicated by Expression (12).

[Math. 12]

γ=[γ_{-M}_{_{g}}, . . . ,γ_{M}_{_{g}}]^{T} (12)

Further, as indicated by Expression (13), a complex vector of (2Mₗ+1)Nₗ×1 obtained by arranging the local mode coefficients α__{(n_l),(m_l)} for the Nₗ high-order speakers constituting the high-order speaker array SP11 is defined as α.

[Math. 13]

α=[α__{l,-M}_{ₗ}, . . . ,α__{l,M}_{ₗ}, . . . ,α__{Nl,-M}_{_{g}}, . . . ,α__{Nl,M}_{ₗ}]^{T} (13)

Here, the relation between the complex vector γ and the complex vector α is indicated by Expression (14).

[Math. 14]

γ=T_{gl}α

(T_{gl})_{m_g,l(n_l,m_l)}=H__{((m_g)+(m_l))}(kR_ₗ)e^{j(m_g)ϕ}^{_{(n_l)}}

[(n_l,m_l)=((n_l)(2Mₗ+1)+(m_l)+Mₗ+1 (14)

It is to be noted that I(n_l,m_l) in Expression (14) represents a function for obtaining an index, and T_{gl} is a transformation matrix of (2M_{g}+1)×(2Mₗ+1)Nₗ. The transformation matrix T_{gl} is a matrix for transforming a local mode coefficient for each of the high-order speakers to a global mode coefficient for the entire high-order speaker array SP11 which is centered on the origin.

### <MIMO>

Further, an adaptive noise cancelling algorithm for performing spatial noise cancelling will be explained.

An algorithm for spatial noise cancelling according to the present technology adaptively updates a filter coefficient of an FIR (Finite Impulse Response)-type filter on the basis of the relation between a reference microphone signal x(k) and an error microphone signal e(k). This algorithm is a kind of adaptive filtering methods.

As a typical adaptive filtering method, a Filtered-X LMS (Least Mean Square) algorithm has been known. Filtered-X LMS has been extended to multi-channel control such as spatial noise cancelling. In addition, a method for transforming a signal to be controlled, to a different domain signal has been proposed.

All the methods, which will be explained below, of spatial noise cancelling to which the present technology is applied, have Filtered-X LMS algorithm structures.

First, an explanation of a MIMO (Multi Input Multi Output) Filtered-X LMS algorithm (hereinafter, simply referred to as MIMO) will be given. Then, an explanation of a local mode adaptive algorithm (hereinafter, simply referred to as MD-LM) and a global mode adaptive algorithm (hereinafter, simply referred to as MD-GM) will be given.

The MIMO-Filtered-X LMS algorithm is derived by natural extension of a single-input/single-output Filtered-X LMS algorithm.

Formulating the Filtered-X LMS algorithm in the array arrangement depicted in FIG. 1 is considered here.

First, a signal of a noise (direct sound) component observed by the error microphone array EMA11, that is, a signal of a direct sound noise which is propagated from the noise source NS11 to the error microphone array EMA11 is defined as d. In this case, a frequency domain signal e observed by the error microphone array EMA11 is obtained as indicated by Expression (15). Here, the frequency domain signal e corresponds to the abovementioned error microphone signal e(k). The signal d of the direct sound is a complex vector of Nₑ×1.

[Math. 15]

e=d+GWx (15)

It is to be noted that G in Expression (15) represents a matrix of Nₑ×QNₗ, and indicates a matrix having an element of a transfer function from the high-order speakers of the high-order speaker array SP11 which is a second-order sound source to the microphones constituting the error microphone array EMA11. This transfer function is called a second-order path.

In addition, W in Expression (15) represents a matrix of QNₗ×Nᵣ, and indicates the value of a FIR filter in terms of a frequency domain, or more specifically, represents a filter coefficient forming the FIR filter. Further, x in Expression (15) represents a complex vector of Nᵣ×1 and corresponds to the abovementioned reference microphone signal x(k).

In order to simplify the later derivation, Expression (15) is rewritten by Expression (16).

[Math. 16]

e=d+GXw (16)

X in Expression (16) represents a matrix of QNₗ×QNₗNᵣ having, as elements, the reference microphone signals x and the zero vectors z, as indicated by Expression (17).

$$\begin{matrix}[ Math . 17 ] & \\ X = [ \begin{matrix}{x}^{T} & {z}^{T} & … & {z}^{T} & {z}^{T} \\ {z}^{T} & {x}^{T} & … & {z}^{T} & {z}^{T} \\ ⋮ & ⋮ & ⋱ & ⋮ & ⋮ \\ {z}^{T} & {z}^{T} & … & {x}^{T} & {z}^{T} \\ {z}^{T} & {z}^{T} & … & {z}^{T} & {x}^{T}\end{matrix} ] ∈ {C}^{{QN}_{l} \times {QN}_{l} {N}_{r}} , & ( 17 ) \\ z = {[ 0 , … , 0 ]}^{T} ∈ {C}^{{N}_{r} \times 1} & \end{matrix}$$

In addition, w in Expression (16) represents a matrix (vector) of QNₗNᵣ×1 obtained by arranging the elements constituting the matrix W, as indicated in Expression (18).

$$\begin{matrix}[ Math . 18 ] & \\ w = [ \begin{matrix}{w}_{1} \\ {w}_{2} \\ ⋮ \\ {w}_{{QN}_{l}}\end{matrix} ] ∈ {C}^{{QN}_{l} {N}_{r} \times 1} , {w}_{n} ∈ {C}^{{N}_{r} \times 1} & ( 18 ) \\ where W = [ \begin{matrix}{w}_{1}^{T} \\ {w}_{2}^{T} \\ ⋮ \\ {w}_{{QN}_{l}}^{T}\end{matrix} ] ∈ {C}^{{QN}_{l} \times {N}_{r}} & \end{matrix}$$

The objective of this control is to minimize a mean square error J, which is indicated by Expression (19), for each frequency, that is, wavenumber k. It is to be noted that E[⋅] in Expression (19) represents an expectation value operation.

[Math. 19]

J=E[e^{H}e] (19)

When the mean square error J is rewritten with use of Expression (16), Expression (20) is obtained.

$$\begin{matrix}[ Math . 20 ] & \\ \begin{matrix}J = E [ {e}^{H} e ] \\ = E [ {( d + GXw )}^{H} ( d + GXw ) ] \\ = E [ {d}^{H} d ] + E [ {w}^{H} {X}^{H} {G}^{H} d ] + \\ E [ {d}^{H} GXw ] + E [ {w}^{H} {X}^{H} {G}^{H} GXw ] \\ = E [ {d}^{H} d ] + {w}^{H} E [ {X}^{H} {G}^{H} d ] + \\ E [ {d}^{H} GX ] w + {w}^{H} E [ {X}^{H} {G}^{H} GX ] w\end{matrix} & ( 20 )\end{matrix}$$

Therefore, the gradient of the mean square error J by the filter coefficient is obtained as indicted by Expression (21).

$$\begin{matrix}[ Math . 21 ] & \\ \begin{matrix}\frac{\partial J}{\partial \overline{w}} = \frac{\partial E [ {e}^{H} e ]}{\partial \overline{w}} \\ = E [ {X}^{H} {G}^{H} d ] + E [ {X}^{H} {G}^{H} GX ] w \\ = E [ {( GX )}^{H} ( d + GXw ) ] \\ = E [ {( GX )}^{H} e ]\end{matrix} & ( 21 )\end{matrix}$$

On the basis of the gradient of the mean square error J thus obtained, the matrix W, which is a filter, that is, the filter coefficient w which forms the filter, is updated. At this time, calculation of the expectation value is difficult because the calculation requires many samples. Therefore, in the LMS algorithm, a calculation result of the expectation value is substituted by an instantaneous value.

Therefore, a filter updating expression based on the LMS algorithm is obtained as indicated by Expression (22).

[Math. 22]

w⁽ⁱ⁺¹⁾=w⁽ⁱ⁾−μ(GₑₛₜX⁽ⁱ⁾)^{H}e⁽ⁱ⁾ (22)

It is to be noted that (i) in Expression (22) represents an index that indicates a time. For example, w⁽ⁱ⁾ and w⁽ⁱ⁺¹⁾ each represent the filter coefficient w, and the filter coefficient w⁽ⁱ⁺¹⁾ indicates the updated filter coefficient w⁽ⁱ⁾. Therefore, (i) can be considered to indicate the number of times of updates.

In addition, μ in Expression (22) is called a step size parameter and represents a parameter for adjusting the updating amount of the filter coefficient w.

For example, when the step size parameter μ is large, the filter coefficient w is converged quickly but is likely to be diverged. In contrast, when the step size parameter μ is small, the filter coefficient w is converted slowly but is unlikely to be diverged.

Further, in Expression (22), Gₑₛₜ represents an estimation value of the matrix G indicated by Expression (15), that is, represents an estimated second-order path.

### Configuration Example of MIMO Spatial Noise Cancelling System

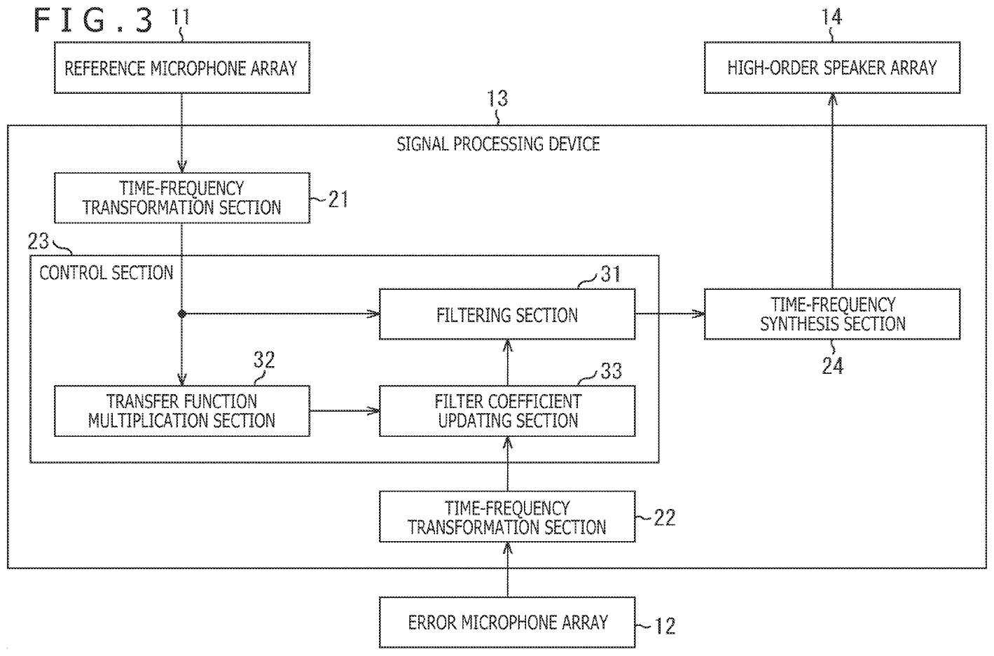

A MIMO-type spatial noise cancelling system which performs spatial noise cancelling by MIMO which has been explained above is configured as depicted in FIG. 3, for example.

The spatial noise cancelling system depicted in FIG. 3 includes a reference microphone array 11, an error microphone array 12, a signal processing device 13, and a high-order speaker array 14.

It is to be noted that the reference microphone array 11, the error microphone array 12, and the high-order speaker array 14 correspond to the reference microphone array RMA11, the error microphone array EMA11, and the high-order speaker array SP11, which are depicted in FIG. 1, respectively.

In addition, arrangement of the reference microphone array 11, the error microphone array 12, and the high-order speaker array 14 is similar to arrangement of the reference microphone array RMA11, the error microphone array EMA11, and the high-order speaker array SP11 depicted in FIG. 1.

The signal processing device 13 generates a speaker drive signal on the basis of a reference microphone signal supplied from the reference microphone array 11 and an error microphone signal supplied from the error microphone array 12 and supplies the speaker drive signal to the high-order speaker array 14.

It is to be noted that the reference microphone array 11 and the error microphone array 12 may be provided in the signal processing device 13, or the high-order speaker array 14 may be provided in the signal processing device 13.

The signal processing device 13 includes a time-frequency transformation section 21, a time-frequency transformation section 22, a control section 23, and a time-frequency synthesis section 24.

A time domain reference microphone signal obtained by collection of ambient sounds at the reference microphone array 11 is supplied to the time-frequency transformation section 21.

The time-frequency transformation section 21 performs time-frequency transformation of the reference microphone signal supplied from the reference microphone array 11 and supplies, to the control section 23, a reference microphone signal x which is a time-frequency spectrum obtained as a result of the time-frequency transformation. For example, by performing FFT (Fast Fourier Transform) as the time-frequency transformation, the time-frequency transformation section 21 transforms the reference microphone signal from a time domain signal to a frequency domain signal.

A time domain error microphone signal obtained by collection of ambient sounds at the error microphone array 12 is supplied to the time-frequency transformation section 22.

The time-frequency transformation section 22 performs time-frequency transformation of the error microphone signal supplied from the error microphone array 12 and supplies, to the control section 23, an error microphone signal e which is a time-frequency spectrum obtained as a result of the time-frequency transformation. For example, by performing FFT as the time-frequency transformation, the time-frequency transformation section 22 transforms the error microphone signal from a time domain signal to a frequency domain signal.

The control section 23 generates a frequency domain speaker drive signal on the basis of the reference microphone signal x supplied from the time-frequency transformation section 21 and the error microphone signal e supplied from the time-frequency transformation section 22 and supplies the speaker drive signal to the time-frequency synthesis section 24.

The control section 23 includes a filtering section 31, a transfer function multiplication section 32, and a filter coefficient updating section 33.

On the basis of the reference microphone signal x supplied from the time-frequency transformation section 21, the filtering section 31 generates the matrix X indicated by Expression (17).

Further, the filtering section 31 generates a frequency domain speaker drive signal by performing a filtering process on the basis of the obtained matrix X and the filter coefficient w supplied from the filter coefficient updating section 33 and supplies the speaker drive signal to the time-frequency synthesis section 24. In the filtering process, the matrix X and the filter coefficient w are convoluted to obtain Xw which is indicated by Expression (16). As a result, the speaker drive signal that corresponds to the abovementioned vector y(k) is obtained.

The speaker drive signal thus generated by the filtering section 31 is used for cancelling a spatial noise sound in a target region, by point control.

The transfer function multiplication section 32 holds a matrix Gₑₛₜ which is a second-order path previously obtained through actual measurement or the like. The matrix Gₑₛₜ is formed of a transfer function indicating the characteristics of transfer from the high-order speakers constituting the high-order speaker array 14 to the microphones constituting the error microphone array 12. It is to be noted that the matrix Gₑₛₜ can be updated each time arrangement in the high-order speaker array 14, etc., is changed.

The transfer function multiplication section 32 obtains a product GₑₛₜX of the matrix X obtained from the reference microphone signal x supplied from the time-frequency transformation section 21 and the held matrix Gₑₛₜ and supplies the product GₑₛₜX to the filter coefficient updating section 33. Such a product GₑₛₜX is obtained by multiplying the reference microphone signal by the transfer function.

The filter coefficient updating section 33 updates the filter coefficient w by calculating Expression (22) on the basis of the product GₑₛₜX supplied from the transfer function multiplication section 32, the current filter coefficient w, and the error microphone signal e supplied from the time-frequency transformation section 22.

The filter coefficient updating section 33 supplies the updated filter coefficient w to the filtering section 31. It is to be noted that the filter coefficient w does not need to be updated constantly, and the update may be conducted at a fixed time interval or at an appropriate timing.

The time-frequency synthesis section 24 performs time-frequency synthesis on the frequency domain speaker drive signal supplied from the filtering section 31 and supplies a time domain speaker drive signal obtained as a result of the time-frequency synthesis to the high-order speaker array 14 such that sounds are outputted from the high-order speaker array 14.

For example, by performing IFFT (Inverse Fast Fourier Transform) as the time-frequency synthesis, the time-frequency synthesis section 24 transforms the speaker drive signal from a frequency domain signal to a time domain signal.

The high-order speaker array 14 cancels a spatial noise sound in a target region by outputting sounds on the basis of the speaker drive signal supplied from the time-frequency synthesis section 24 so that spatial noise cancelling for the target region is performed. That is, sounds outputted, at a plurality of control points, from the high-order speaker array 14 cancel the spatial noise sound.

As explained so far, spatial noise cancelling is performed by outputting sounds from the high-order speaker array 14 while updating the filter coefficient w, as appropriate.

In particular, the MIMO spatial noise cancelling system depicted in FIG. 3 can output sounds having any directivities as a result of using the high-order speaker array 14. Accordingly, high-performance spatial noise cancelling can be performed. That is, a higher spatial noise cancelling effect can be attained. Further, since the high-order speaker array 14 is used, the spatial noise cancelling can be performed with a saved space.

In the above explanation, the high-order speaker array 14 is used for spatial noise cancelling. However, a speaker array obtained by combining a high-order speaker and a normal speaker that is not a high-order speaker and is capable of reproducing a single directivity only, may be used. This is true not only for MIMO but also for MD-GM and MD-LM, which will be explained later.

In such a case, a speaker array including at least one high-order speaker or a normal speaker outputs sounds on the basis of a speaker drive signal supplied from the time-frequency synthesis section 24. Accordingly, spatial noise cancelling is performed.

Here, it is more effective to use, for example, a normal speaker having a greater diameter than a high-order speaker in order to cancel a low-band component of a spatial noise sound, that is, to use a high-order speaker and a normal speaker in order to cancel different frequency bands.

Meanwhile, an objective of the MIMO spatial noise cancelling system depicted in FIG. 3 is to minimize signals obtained at the positions of the microphones constituting the error microphone array 12, that is, to minimize spatial noise sounds. Thus, spatial noise cancelling in the target region is performed by point control.

Therefore, in the MIMO spatial noise cancelling system depicted in FIG. 3, there is no guarantee that a sound pressure at any position other than the positions of the microphones constituting the error microphone array 12 is reduced.

For example, according to “T. Nakashima and S. Ise. A theoretical study of the discretization of the boundary surface in the boundary surface control principle. Acoustical science and technology, 27(4):199-205, 2006.” it is reported that, in a case where the microphones constituting the error microphone array 12 are arranged at a sufficiently smaller interval with respect to a sound wavelength, a sound pressure at any position other than the positions of the microphones is also reduced.

However, the performance of spatial noise cancelling becomes inferior, compared with MD-LM or MD-GM, which will be explained later. MD-LM or MD-GM is a method for minimizing an error in terms of a mode domain.

In addition, in the MIMO spatial noise cancelling system depicted in FIG. 3, the computation amount of adaptive processes of generating a speaker drive signal while updating the filter coefficient w becomes large.

That is, in the embodiment in FIG. 3, processes in the entire spatial noise cancelling system are classified into a filtering process mainly using the filter coefficient w, and a filter coefficient updating process for updating the filter coefficient w.

The filtering process is a process for obtaining Ex in Expression (15), that is, Xw in Expression (16), and corresponds to QNₗ×Nᵣ time-domain convolution processes.

In addition, the filter coefficient updating process is a computation process indicated by Expression (22). In this computation, a computation amount becomes the maximum when GₑₛₜX is obtained.

The matrix Gₑₛₜ is Nₑ×QNₗ. The matrix X is QNₗ×QNₗNᵣ. Thus, even when calculation of a zero matrix part in the matrix X is omitted, the computation amount (calculation amount) of computing GₑₛₜX for each frequency is O(Nₑ(QNₗ)²Nᵣ).

For example, when Nₑ=16, Q=16, Nₗ=6 (that is, the total number of drivers QNₗ=96), Nᵣ=16, buffer size and filter length are 1024 samples, and a sampling frequency is 48 kHz, 48000/1024×513×16×96²×16=5.7×10¹⁰.

Accordingly, multiplication/addition using C as a constant is required by C×5.7×10¹⁰ times/second. Thus, reduction in the actual computation amount can be tried through restrictions on a frequency at which the filter coefficient w is updated or through decrease of the updating frequency. However, it is difficult to perform spatial noise cancelling by normal hardware such as a general-use CPU (Central Processing Unit).

### <MD-GM>

To this end, in the present technology, not only a high-order speaker array is used, but also a filtering process and a filter coefficient updating process in terms of a mode domain (wavenumber domain) are performed. Accordingly, spatial noise cancelling that exhibits sufficient performance can be performed with a saved space and a small computation amount.

A method of performing a filtering process and a filter coefficient updating process in terms of a mode domain, as described above, is a global mode adaptive algorithm (MD-GM).

MD-GM is natural extension under a circumstance using a high-order speaker in accordance with a NWD-M algorithm. It is to be noted that the NWD-M algorithm is described in detail in “J. Zhang, T. D. Abhayapala, W. Zhang, P. N. Samarasinghe, and S. Jiang. Active noise control over space: A wave domain approach. IEEE/ACM Transactions on Audio, Speech and Language Processing (TASLP), 26(4):774-786, 2018.” for example.

Further, in contrast to point control in MIMO, area control for decreasing the total sound pressure in a target region is performed in spatial noise cancelling in MD-GM. Specifically, during the area control, a speaker drive signal is generated such that the wavefront of the total sound in a target region becomes a desired wavefront as a result of wavefront synthesis using a plurality of high-order speakers. The desired wavefront means a wavefront that cancels the wavefront of a spatial noise sound.

First, transformation matrices indicated by Expression (23) and Expression (24) are defined preliminarily.

[Math. 23]

T_{lg}T_{gl}⁺ (23)

[Math. 24]

Tₛₗ=Tₗₛ⁺ (24)

In Expression (23) and Expression (24), A⁺ represents a pseudo-inverse matrix of a matrix A.

For example, the transformation matrix T_{gl} is a matrix for transforming a local mode coefficient for a high-order speaker to a global mode coefficient, as indicated by Expression (14). Therefore, the transformation matrix T_{lg} is a matrix for transforming a global mode coefficient to a local mode coefficient for the high-order speaker.

Likewise, the transformation matrix Tₗₛ is a matrix for transforming the frequency domain drive signal y_{n_l} for a high-order speaker, that is, a speaker drive signal to a local mode coefficient for each driver of the high-order speaker, as indicated by Expression (7). Accordingly, the transformation matrix Tₛₗ is a matrix for transforming the local mode coefficient for each driver of the high-order speaker, to a frequency domain speaker drive signal for the high-order speaker.

In MD-GM, the reference microphone signal x is transformed to a global mode domain signal, that is, a global mode coefficient by the transformation matrix T_{gr}.

Then, a filtering process using a filter coefficient is performed on the obtained global mode coefficient so that a global mode coefficient which is the filter output is obtained. The global mode coefficient thus obtained is a global mode domain speaker drive signal.

Thereafter, the global mode coefficient obtained as the mode domain speaker drive signal is transformed to a local mode coefficient for each high-order speaker by the transformation matrix T_{lg}. Further, the local mode coefficient is transformed to a frequency domain speaker drive signal for each driver of the high-order speaker by the transformation matrix Tₛₗ.

Here, the error microphone signal e can be indicated by Expression (25).

$$\begin{matrix}[ Math . 25 ] & \\ \begin{matrix}e = d + {G ( {T}_{gl} {T}_{ls} )}^{+} {W}_{GM} {T}_{g r} x \\ = d + {GT}_{sl} {T}_{lg} {W}_{GM} {T}_{g r} x\end{matrix} & ( 25 )\end{matrix}$$

In Expression (25), d represents a signal of a direct sound as in Expression (15), and G represents a matrix of Nₑ×QNₗ having an element of a transfer function from the high-order speakers of the high-order speaker array SP11 to the microphones constituting the error microphone array EMA11.

Also, W_{GM} in Expression (25) represents a filter coefficient and is a diagonal matrix of (2M_{g}+1)×(2M_{g}+1). Hereinafter, the matrix W_{GN} is defined for derivation, as indicated by Expression (26).

[Math. 26]

W_{GM}=diag(w_{-Mg}, . . . ,w_{Mg})∈C^{(2M}^{_{g}}^{+1)×(2M}^{_{g}}⁺¹⁾ (26)

Here, a global mode coefficient e′ for the error microphone signal e can be obtained from the transformation matrix T_{ge} and the error microphone signal e by Expression (27).

$$\begin{matrix}[ Math . 27 ] & \\ \begin{matrix}{e}^{′} = {T}_{ge} e \\ = {T}_{ge} d + {T}_{ge} {GT}_{sl} {T}_{lg} {W}_{GM} {T}_{g r} x \\ = {d}^{′} + {g}^{′} {W}_{GM} {x}^{′} \\ = {d}^{′} + {g}^{′} {X}^{′} {w}_{GM}\end{matrix} & ( 27 )\end{matrix}$$

In Expression (27), d′=T_{ge}d, g′=T_{ge}GTₛₗT_{lg}, x′=T_{grx}, and x′ represents a global mode coefficient of the reference microphone signal x. In ideal arrangement having high-order speakers arranged at an equal interval into a ring-like shape, T_{ge}GTₛₗT_{lg} can be approximated to a diagonal matrix. Accordingly, a diagonal matrix obtained by extracting only diagonal components from T_{ge}GTₛₗT_{lg} is defined as a matrix g′ here.

In Expression (27), X′ represents a diagonal matrix of (2M_{g}+1)×(2M_{g}+1) obtained by diagonally arranging the components of the global mode coefficient x′.

Further, W_{GM} represents a vector formed of diagonal components, as indicated by Expression (28), and is also referred to as filter coefficient w_{GM}.

[Math. 28]

w_{GM}=[w_{-Mg}, . . . ,w_{Mg}]^{T}∈C^{(2M}^{_{g}}^{+1)×1} (28)

Here, in order to minimize the mean square error J_{global} of the global mode coefficient e′, Expression (29) is given.

$$\begin{matrix}[ Math . 29 ] & \\ \begin{matrix}{J}_{global} = E [ {e}^{′ H} {e}^{′} ] \\ = E [ {d}^{′ H} {d}^{′} ] + {w}_{GM}^{H} E [ {X}^{′ H} {g}^{′ H} {d}^{′} ] + \\ E [ {d}^{′ H} {g}^{′} {X}^{′} ] {w}_{GM} + {w}_{GM}^{H} E [ {X}^{′ H} {g}^{′ H} {g}^{′} {X}^{′} ] {w}_{GM}\end{matrix} & ( 29 )\end{matrix}$$

Therefore, a gradient regarding the filter coefficient w_{GN} of the mean square error J_{global} is obtained as indicated by Expression (30). Thus, a filter updating expression based on the LMS algorithm is obtained as indicated in Expression (31).

$$\begin{matrix}[ Math . 30 ] & \\ \begin{matrix}\frac{\partial {J}_{global}}{\partial \overline{{w}_{GM}}} = \frac{\partial E [ {e}^{′ H} {e}^{′} ]}{\partial \overline{{w}_{GM}}} \\ = E [ {X}^{′ H} {g}^{′ H} {d}^{′} ] + E [ {X}^{′ H} {g}^{′ H} {g}^{′} {X}^{′} ] {w}_{GM} \\ = E [ {X}^{′ H} {g}^{′ H} {e}^{′} ]\end{matrix} & ( 30 ) \\ [ Math . 31 ] & \\ {w}_{GM}^{( i + 1 )} = {w}_{GM}^{( i )} - {μ ( {g}_{est}^{′} {X}^{′ ( i )} )}^{H} {e}^{′} & ( 31 )\end{matrix}$$

It is to be noted that (i) in Expression (31) represents an index that indicates a time. For example, w_{GN}⁽ⁱ⁾ and w_{GN}⁽ⁱ⁺¹⁾ each represent the filter coefficient w_{GN}, and the filter coefficient w_{GM}⁽ⁱ⁺¹⁾ indicates the updated filter coefficient w_{GM}⁽ⁱ⁾. Therefore, (i) can be considered to indicate the number of times of updates.

In addition, p in Expression (31) is called a step size parameter similar to that in Expression (22). Further, g′ₑₛₜ in Expression (31) represents an estimation value of the matrix g′, that is, a matrix formed of an estimated second-order path (transfer function).

### Configuration Example of MD-GM Spatial Noise Cancelling System

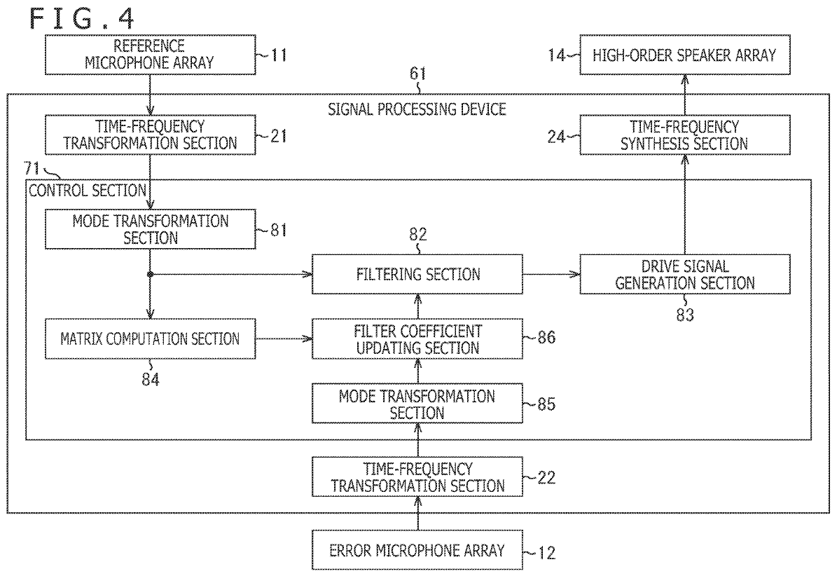

An MD-GM spatial noise cancelling system for performing spatial noise cancelling by MD-GM which has be explained above, is configured as depicted in FIG. 4, for example. It is to be noted that components in FIG. 4 corresponding to those in FIG. 3 are denoted by the same reference signs, and an explanation thereof will be omitted, as appropriate.

The spatial noise cancelling system depicted in FIG. 4 includes the reference microphone array 11, the error microphone array 12, a signal processing device 61, and the high-order speaker array 14.

The signal processing device 61 includes the time-frequency transformation section 21, the time-frequency transformation section 22, a control section 71, and the time-frequency synthesis section 24. Further, the control section 71 includes a mode transformation section 81, a filtering section 82, a drive signal generation section 83, a matrix computation section 84, a mode transformation section 85, and a filter coefficient updating section 86.

The mode transformation section 81 transforms a reference microphone signal x to a global mode coefficient x′ on the basis of the reference microphone signal x supplied from the time-frequency transformation section 21 and the previously held transformation matrix T_{gr} and supplies the reference microphone signal x to the filtering section 82 and the matrix computation section 84.

The filtering section 82 performs a filtering process in terms of a wavenumber domain on the basis of the global mode coefficient x′ supplied from the mode transformation section 81 and the filter coefficient w_{GN} supplied from the filter coefficient updating section 86. Specifically, at the filtering section 82, a filtering process using the filter coefficient w_{GN} is performed on the global mode coefficient x′ so that a speaker drive signal is generated.

The filtering section 82 supplies, to the drive signal generation section 83, a global mode domain (wavenumber domain) speaker drive signal obtained as a result of the filtering process. The speaker drive signal generated in such a manner by the filtering section 82 is used for cancelling a spatial noise sound which is propagated to the target region, by area control.

The drive signal generation section 83 generates a frequency domain speaker drive signal, that is, a drive signal for each driver of a high-order speaker on the basis of the speaker drive signal supplied from the filtering section 82, the previously held transformation matrix T_{lg}, and the previously held transformation matrix Tₛₗ and supplies the speaker drive signal to the time-frequency synthesis section 24.

The drive signal generation section 83 performs a transformation process of transforming a global mode domain speaker drive signal, that is, a global mode coefficient to a local mode domain speaker drive signal, that is, a local mode coefficient on the basis of the transformation matrix T_{lg} and performs a transformation process of transforming a local mode domain speaker drive signal to a frequency domain speaker drive signal on the basis of the transformation matrix Tₛₗ.

It is to be noted that these transformation processes may be performed in order or may be performed simultaneously in the drive signal generation section 83. In addition, these transformation processes and the time-frequency synthesis may be performed simultaneously in the drive signal generation section 83.

The matrix computation section 84 holds a previously obtained matrix g′ₑₛₜ. The matrix g′ₑₛₜ indicates an estimation value of a characteristic of transfer (second-order path) from the high-order speakers constituting the high-order speaker array 14 to the microphones constituting the error microphone array 12. It is to be noted that the matrix g′ₑₛₜ can be updated each time arrangement in the high-order speaker array 14, etc., is changed.

The matrix computation section 84 obtains a product g′ₑₛₜX′ of the matrix X′ obtained from the global mode coefficient x′ supplied from the mode transformation section 81 and the held matrix g′ₑₛₜ and supplies the product g′ₑₛₜX′ to the filter coefficient updating section 86.

The mode transformation section 85 transforms the error microphone signal e to a global mode coefficient e′ on the basis of the error microphone signal e supplied from the time-frequency transformation section 22 and the previously held transformation matrix T_{ge} and supplies the global mode coefficient e′ to the filter coefficient updating section 86.

The filter coefficient updating section 86 updates the filter coefficient w_{GM} on the basis of the product g′ₑₛₜX′ supplied from the matrix computation section 84, the current filter coefficient w_{GM}, and the global mode coefficient e supplied from the mode transformation section 85. The filter coefficient updating section 86 supplies the updated filter coefficient w_{GM} to the filtering section 82. It is to be noted that the filter coefficient w_{GM} does not need to be updated constantly, and the update may be conducted at a fixed time interval or at an appropriate timing.

Here, wavenumber domain processing, that is, computation processing in a mode domain is performed at the filtering section 82, the matrix computation section 84, and the filter coefficient updating section 86.

### <Explanation of Spatial Noise Cancelling Process>

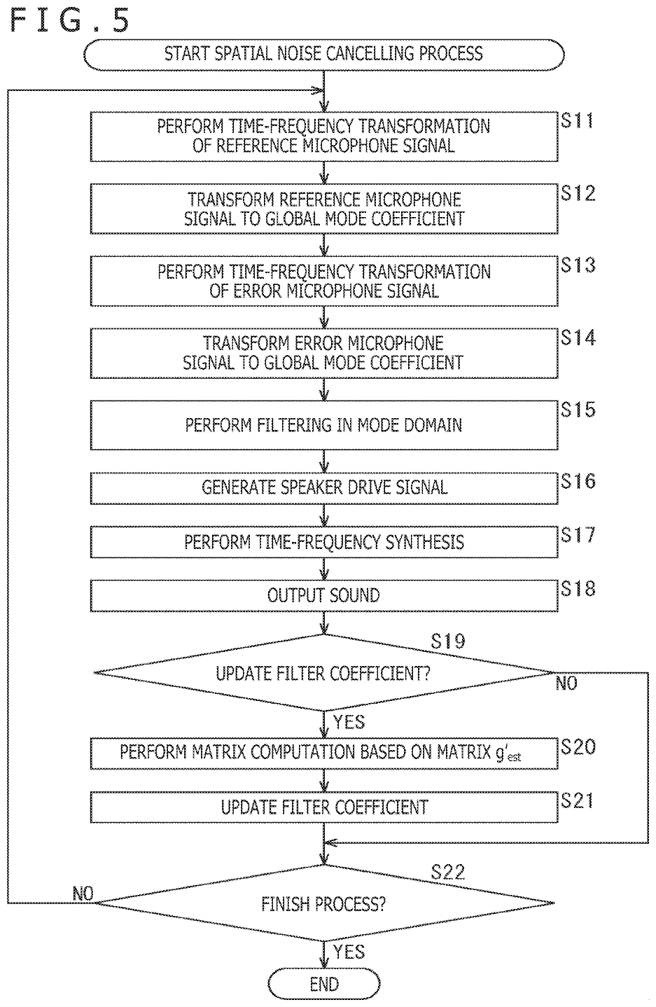

Next, operation of the MD-GM spatial noise cancelling system depicted in FIG. 4 will be explained. Specifically, a spatial noise cancelling process which is executed in the spatial noise cancelling system will be explained with reference to a flowchart in FIG. 5.

It is to be noted that, when the spatial noise cancelling process is started, the reference microphone array 11 collects ambient sounds and sequentially supplies, to the time-frequency transformation section 21, a time domain reference microphone signal obtained as a result of the sound collection. Also, the error microphone array 12 collects ambient sounds and sequentially supplies, to the time-frequency transformation section 22, a time domain error microphone signal obtained as a result of the sound collection.

In step S11, the time-frequency transformation section 21 performs time-frequency transformation of the reference microphone signal supplied from the reference microphone array 11 and supplies to the mode transformation section 81, a reference microphone signal x obtained as a result of the time-frequency transformation. For example, FFT is performed as the time-frequency transformation in step S11.

In step S12, the mode transformation section 81 transforms the reference microphone signal x supplied from the time-frequency transformation section 21 to a global mode coefficient x′ on the basis of the transformation matrix T_{gr} and supplies the global mode coefficient x′ to the filtering section 82 and the matrix computation section 84. Specifically, in step S12, a product T_{gr}x of the transformation matrix T_{gr} and the reference microphone signal x is obtained as a global mode coefficient x′.

In step S13, the time-frequency transformation section 22 performs time-frequency transformation of the error microphone signal supplied from the error microphone array 12 and supplies, to the mode transformation section 85, an error microphone signal e obtained as a result of the time-frequency transformation. For example, FFT is performed as the time-frequency transformation in step S13.

In step S14, the mode transformation section 85 transforms the error microphone signal e supplied from the time-frequency transformation section 22 to a global mode coefficient e′ on the basis of the transformation matrix T_{ge} and supplies the global mode coefficient e′ to the filter coefficient updating section 86. Specifically, in step S14, a product T_{ge}e of the transformation matrix T_{ge} and the error microphone signal e is obtained as the global mode coefficient e′.

In step S15, the filtering section 82 performs a filtering process in terms of a wavenumber domain (mode domain) on the basis of the global mode coefficient x′ supplied from the mode transformation section 81 and the filter coefficient w_{GM} supplied from the filter coefficient updating section 86.

Specifically, the filtering section 82 generates the abovementioned matrix X′ indicated by Expression (27) on the basis of the global mode coefficient x′ and obtains, as a wavenumber domain speaker drive signal, a global mode coefficient by obtaining a product X′w_{GM} of the matrix X′ and the filter coefficient w_{GM}. The filtering section 82 supplies the speaker drive signal thus obtained to the drive signal generation section 83.

The filtering section 82 obtains, as a speaker drive signal, W_{GM}T_{gr}x=X′w_{GN} indicated by Expression (27). The speaker drive signal can be obtained by a small computation amount because the matrix W_{GM} of filter coefficients is a diagonal matrix. As a result of the filtering process in terms of a wavenumber domain (mode domain), the computation amount can be reduced in such a manner.

In step S16, the drive signal generation section 83 generates a frequency domain speaker drive signal on the basis of the speaker drive signal supplied from the filtering section 82 and the transformation matrix T_{lg} and transformation matrix Tₛₗ and supplies the frequency domain speaker drive signal to the time-frequency synthesis section 24.

Specifically, the drive signal generation section 83 calculates a product TₛₗT_{lg}X′w_{GM} of the speaker drive signal X′w_{GM}, the transformation matrix T_{lg}, and the transformation matrix Tₛₗ. The calculation result is the frequency domain speaker drive signal.

When calculating (computing) the product TₛₗT_{lg}X′w_{GM}, the drive signal generation section 83 performs computation of up to at least a term corresponding to at least a predetermined first or higher order radiation pattern of the high-order speaker, that is, a term corresponding to the index of a base of a ring-like harmonic function.

Here, an index (m_l) in the transformation matrix T_{lg} or the transformation matrix Tₛₗ corresponds to the index of a basis of the ring-like harmonic function. Therefore, in a case where the maximum order number Mₗ=1, for example, a wavefront of a sound having a directivity obtained by combining the zero-order radiation pattern of the high-order speaker and the first-order radiation pattern of the high-order speaker can be formed in the target region.

Likewise, in a case where the maximum order number Mₗ=2, a wavefront of a sound having a directivity obtained by combining the zero-order radiation pattern to the second-order radiation pattern of the high-order speaker can be formed in the target region.

At the drive signal generation section 83, the frequency domain speaker drive signal is obtained with the maximum order number Mₗ set to 1 or higher. Accordingly, by combining many radiation patterns, a proper wavefront is formed in the target region, whereby the performance of spatial noise cancelling can be improved.

In step S17, the time-frequency synthesis section 24 performs time-frequency synthesis of the frequency domain speaker drive signal supplied from the drive signal generation section 83 and supplies a time domain speaker drive signal obtained as a result of the time-frequency synthesis to the high-order speaker array 14. For example, IFFT is performed as the time-frequency synthesis in step S17.

In step S18, the high-order speaker array 14 outputs a sound on the basis of the speaker drive signal supplied from the time-frequency synthesis section 24 so that a wavefront of a sound for cancelling a spatial noise sound is formed in the target region. Thus, a sound for cancelling a spatial noise sound is outputted.

Consequently, in the target region which is surrounded by the high-order speaker array 14, a sound (spatial noise sound) which is propagated from the outside is cancelled to become inaudible.

In step S19, the control section 71 determines whether or not to update the filter coefficient w_{GM}.

In a case where it is determined, in step S19, not to update the filter coefficient w_{GM}, step S20 and step S21 are skipped. Then, the process proceeds to step S22.

On the other hand, it is determined, in step S19, to update the filter coefficient w_{GM}, the process proceeds to step S20.

In step S20, the matrix computation section 84 performs a matrix computation of the global mode coefficient x′ supplied from the mode transformation section 81 on the basis of the held matrix g′ₑₛₜ. Specifically, the matrix computation section 84 generates a matrix X′ on the basis of the global mode coefficient x′, obtains a product g′ₑₛₜX′ of the matrix X′ and the matrix g′ₑₛₜ, and supplies the product g′ₑₛₜX′ to the filter coefficient updating section 86.

Since the matrix g′ₑₛₜ is a diagonal matrix, the matrix computation section 84 can obtain g′ₑₛₜX′ by a small computation amount. In particular, regarding a process for updating the filter coefficient, the computation amount in the matrix computation section 84 is larger than the computation amount in the filter coefficient updating section 86. Therefore, reduction in the computation amount in the matrix computation section 84 produces a significant effect. As a result of the filter coefficient updating process in terms of a wavenumber domain (mode domain), the computation amount is reduced as explained above.

In step S21, the filter coefficient updating section 86 updates the filter coefficient w_{GM} on the basis of the product g′ₑₛₜX′ supplied from the matrix computation section 84, the current filter coefficient w_{GM}, and the global mode coefficient e′ supplied from the mode transformation section 85.

Specifically, the filter coefficient updating section 86 updates the filter coefficient w_{GM} by calculating the abovementioned updating expression indicated by Expression (31) and supplies the updated filter coefficient w_{GM} to the filtering section 82. After the filter coefficient w_{GM} is updated, the process proceeds to step S22.

In a case where step S21 has been executed or it is determined, in step S19, not to update the filter coefficient w_{GM}, the control section 71 determines, in step S22, whether or not to finish the process. For example, it is determined to finish the process in step S22 to finish the spatial noise cancelling.

In a case where it is determined, in step S22, not to finish the process, the process returns to step S11, and the abovementioned steps are repeated.

On the other hand, in a case where it is determined, in step S22, to finish the process, operations that are being executed in the sections of the spatial noise cancelling system are stopped, whereby the spatial noise cancelling process is finished.

In the manner described so far, the spatial noise cancelling system outputs a sound from the high-order speaker array 14 while performing a filtering process and a filter coefficient updating process in terms of a wavenumber domain.

As a result of the filtering process and the filter coefficient updating process in terms of a wavenumber domain, the computation amount can be reduced. In addition, since the high-order speaker array 14 is used, high-performance spatial noise cancelling can be performed with a saved space. That is, according to the MD-GM spatial noise cancelling system, spatial noise cancelling that exhibits high performance can be performed with a saved space and a small computation amount.

### Second Embodiment

### <MD-LM>

Meanwhile, in MD-GM, the matrix g′ₑₛₜ is used as an estimation value of a second-order path, that is, an estimation value of the matrix g′. However, it is not easy to estimate the matrix g′.

Estimation of a second-order path is conducted commonly by measurement of an impulse response. However, a directly measured value is the matrix G. Therefore, for each algorithm, the matrix G needs to be transformed to a proper form of a second-order path. That is, in MD-GM, transformation of the matrix G to the matrix g′ₑₛₜ is required.

As described above, in MD-GM, the matrix g′ₑₛₜ which is an estimation value of a second-order path is defined by g′ₑₛₜ=T_{ge}GTₛₗT_{lg}. However, it is difficult to obtain a proper matrix g′ₑₛₜ.

That is, the matrix g′ₑₛₜ=T_{ge}GTₛₗT_{lg} which is a diagonal matrix under an ideal environment which is a free space where no noise is measured, is not necessarily a diagonal matrix under an actual environment. Also, in a case where the transformation matrix T_{gl} which cannot be measured actually includes an error with respect to an ideal environment, the performance of spatial noise cancelling is likely to be deteriorated.

To this end, only the filter coefficient updating process may be performed in a wavenumber domain such that the difficulty in estimating a second-order path in MD-GM is solved, and high-performance spatial noise cancelling is performed.

By the local mode adaptive algorithm (MD-LM), only the filter coefficient updating process is performed in terms of a wavenumber domain with use of a more proper second-order path so that higher-performance spatial noise cancelling can be performed.

First, a process of deriving MD-LM will be explained.

When a matrix of (2Mₗ+1)Nₗ×(2M_{g}+1) formed of a filter coefficient is defined as W_{LM}, the error microphone signal e is indicated by Expression (32). It is to be noted that the transformation matrix Tₛₗ and the transformation matrix T_{gr} are similar to those in Expression (25).

[Math. 32]

e=d+GTₛₗW_{LM}T_{gr}x (32)

Here, the matrix W_{LM} is a linear system in which a global mode coefficient is received as an input, and a local mode coefficient for a high-order speaker is outputted. The global mode coefficient e′ for the error microphone signal e can be obtained by Expression (33).

$$\begin{matrix}[ Math . 33 ] & \\ \begin{matrix}{e}^{′} = {T}_{ge} e \\ = {T}_{ge} d + {T}_{ge} {GT}_{sl} {W}_{LM} {T}_{g r} x \\ = {d}^{′} + {g}^{′} {T}_{gl} {W}_{LM} {x}^{′} \\ = {d}^{′} + {g}^{′} {T}_{gl} {X}^{′} {w}_{LM}\end{matrix} & ( 33 )\end{matrix}$$

In Expression (33), d′=T_{ge}d, g′=T_{ge}GTₛₗT_{lg}, and x′=T_{gr}x. Further, x′ represents a global mode coefficient for the reference microphone signal x.

In order to simplify the later derivation, X′ and w_{LM} are defined as indicated by Expression (34) and Expression (35), respectively. In Expression (34), z represents a zero vector.

$$\begin{matrix}[ Math . 34 ] & \\ {X}^{′} = [ \begin{matrix}{x}^{′ T} & {z}^{T} & … & {z}^{T} & {z}^{T} \\ {z}^{T} & {x}^{′ T} & … & {z}^{T} & {z}^{T} \\ ⋮ & ⋮ & ⋱ & ⋮ & ⋮ \\ {z}^{T} & {z}^{T} & … & {x}^{′ T} & {z}^{T} \\ {z}^{T} & {z}^{T} & … & {z}^{T} & {x}^{′ T}\end{matrix} ] ∈ {C}^{( 2 {M}_{l} + 1 ) {N}_{l} \times ( 2 {M}_{l} + 1 ) {N}_{l} ( 2 {M}_{g} + 1 )} & ( 34 ) \\ [ Math . 35 ] & \\ {w}_{LM} = [ \begin{matrix}{w}_{1} \\ {w}_{2} \\ ⋮ \\ {w}_{( 2 {M}_{l} + 1 ) {N}_{l}}\end{matrix} ] ∈ {C}^{( 2 {M}_{l} + 1 ) {N}_{l} ( 2 {M}_{g} + 1 )} , {w}_{n} ∈ {C}^{( 2 {M}_{g} + 1 ) \times 1} & ( 35 ) \\ where {W}_{LM} = [ \begin{matrix}{w}_{1}^{T} \\ {w}_{2}^{T} \\ ⋮ \\ {w}_{( 2 {M}_{l} + 1 ) {N}_{l}}^{T}\end{matrix} ] ∈ {C}^{( 2 {M}_{l} + 1 ) {N}_{l} \times ( 2 {M}_{g} + 1 )} & \end{matrix}$$

As in MD-GM, the mean square error J_{global} of the global mode coefficient e′ is calculated, as indicated by Expression (36).

$$\begin{matrix}[ Math . 36 ] & \\ \begin{matrix}{J}_{global} = E [ {e}^{′ H} {e}^{′} ] \\ = E [ {d}^{′ H} {d}^{′} ] + {w}_{LM}^{H} E [ {X}^{′ H} {T}_{gl}^{H} {g}^{′ H} {d}^{′} ] + \\ E [ {d}^{′ H} {g}^{′} {T}_{gl} {X}^{′} ] {w}_{LM} + {w}_{LM}^{H} E [ {X}^{′ H} {T}_{gl}^{H} {g}^{′ H} {g}^{′} {T}_{gl} {X}^{′} ] {w}_{LM}\end{matrix} & ( 36 )\end{matrix}$$

Therefore, a gradient regarding the filter coefficient w_{LM} of the mean square error J_{global} is obtained, as indicated by Expression (37). Thus, a filter updating expression based on the LMS algorithm is obtained, as indicated by Expression (38).

$$\begin{matrix}[ Math . 37 ] & \\ \begin{matrix}\frac{\partial {J}_{global}}{\partial \overline{{w}_{LM}}} = \frac{\partial E [ {e}^{′ H} {e}^{′} ]}{\partial \overline{{w}_{LM}}} \\ = E [ {X}^{′ H} {T}_{gl}^{H} {g}^{′ H} {d}^{′} ] + E [ {X}^{′ H} {T}_{gl}^{H} {g}^{′ H} {g}^{′} {T}_{gl} {X}^{′} ] {w}_{LM} \\ = E [ {( {g}^{′} {T}_{gl} {X}^{′} )}^{H} {e}^{′} ]\end{matrix} & ( 37 ) \\ [ Math . 38 ] & \\ {w}_{LM}^{( i + 1 )} = {w}_{LM}^{( i )} - {μ ( {g}^{′} {T}_{gl} {X}^{′ ( i )} )}^{H} {e}^{′ ( i )} & ( 38 )\end{matrix}$$

It is to be noted that (i) in Expression (38) represents an index that indicates a time. For example, w_{LM}⁽ⁱ⁾ and w_{LM}⁽ⁱ⁺¹⁾ each represent the filter coefficient w_{LN}, and the filter coefficient w_{LM}⁽ⁱ⁺¹⁾ indicates the updated filter coefficient w_{LM}⁽ⁱ⁾. Therefore, (i) can be considered to indicate the number of times of updates. Further, μ in Expression (38) represents a step size parameter similar to that in Expression (22).

Further, in Expression (38), a second-order path obtained by actual measurement can be used.

That is, a second-order path in MD-LM is g′T_{gl}=T_{ge}GTₛₗ from Expression (33), and the transformation matrix T_{ge} and the transformation matrix Tₛₗ are constant matrices to be set when the algorithm is executed. Thus, if the matrix G is obtained correctly, the second-order path can be obtained correctly. Further, the transformation matrix Tₛₗ can be calculated by using an actually measured value because the transformation matrix Tₗₛ, which has an inverse characteristic to that of the transformation matrix Tₛₗ, can be measured through measurement of an impulse response from each driver of the high-order speaker to the neighboring ring-like microphone array.

### Configuration Example of MD-LM Spatial Noise Cancelling System

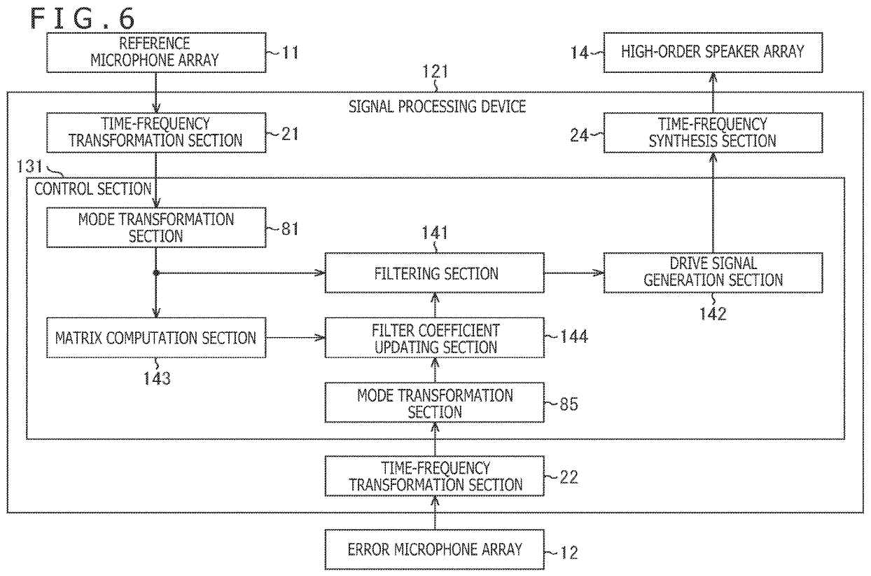

An MD-LM spatial noise cancelling system for performing spatial noise cancelling in MD-LM which has been explained above, is configured as depicted in FIG. 6, for example. It is to be noted that components in FIG. 6 corresponding to those in FIG. 4 are denoted by the same reference signs, and an explanation thereof will be omitted, as appropriate.

The spatial noise cancelling system depicted in FIG. 6 includes the reference microphone array 11, the error microphone array 12, a signal processing device 121, and the high-order speaker array 14.

The signal processing device 121 includes the time-frequency transformation section 21, the time-frequency transformation section 22, a control section 131, and the time-frequency synthesis section 24. In addition, the control section 131 includes the mode transformation section 81, a filtering section 141, a drive signal generation section 142, a matrix computation section 143, the mode transformation section 85, and a filter coefficient updating section 144.

The filtering section 141 performs a filtering process on the basis of the global mode coefficient x′ supplied from the mode transformation section 81 and the filter coefficient w_{LM} supplied from the filter coefficient updating section 144. Specifically, at the filtering section 141, a filtering process using the filter coefficient w_{LM} is performed on the global mode coefficient x′ so that a speaker drive signal is generated.

The filtering section 141 supplies a local mode domain (wavenumber domain) speaker drive signal obtained as a result of the filtering process, that is, a local mode coefficient for a high-order speaker to the drive signal generation section 142. The speaker drive signal thus generated by the filtering section 141 is used for cancelling a spatial noise sound that is propagated to the target region, by area control.

The drive signal generation section 142 generates a frequency domain speaker drive signal, that is, a driver signal for each driver of the high-order speaker on the basis of the speaker drive signal supplied from the filtering section 141 and the previously held transformation matrix Tₛₗ and supplies the frequency domain speaker drive signal to the time-frequency synthesis section 24. The drive signal generation section 142 performs a transformation process of transforming a local mode domain speaker drive signal, that is, a local mode coefficient to a frequency domain speaker drive signal on the basis of the transformation matrix Tₛₗ.

The matrix computation section 143 holds a matrix g′ₑₛₜT_{gl} which is previously obtained through actual measurement or the like. The matrix g′ₑₛₜT_{gl} indicates an estimation value of a characteristic of a transfer (second-order path) from the high-order speakers constituting the high-order speaker array 14 to the microphones constituting the error microphone array 12. It is to be noted that the matrix g′ₑₛₜT_{gl} can be updated each time arrangement in the high-order speaker array 14 or the like is changed.

The matrix computation section 143 obtains a product g′ₑₛₜT_{gl}X′ of the matrix X′ obtained from the global mode coefficient x′ supplied from the mode transformation section 81 and the held matrix g′ₑₛₜT_{gl} and supplies the product g′ₑₛₜT_{gl}X′ to the filter coefficient updating section 144.

The filter coefficient updating section 144 updates the filter coefficient w_{LM} on the basis of the product g′ₑₛₜT_{gl}X′ supplied from the matrix computation section 143, the current filter coefficient w_{LM}, and the global mode coefficient e supplied from the mode transformation section 85. The filter coefficient updating section 144 supplies the updated filter coefficient w_{LM} to the filtering section 141. It is to be noted that the filter coefficient w_{LM} does not need to be updated constantly, and the update may be conducted at a fixed time interval or at an appropriate timing.

Here, the processes which are performed at the matrix computation section 143 and the filter coefficient updating section 144 are wavenumber domain processes, that is, computation processes in a mode domain.

In addition, in MD-LM, arrangement of the high-order speakers constituting the high-order speaker array 14 is not limited to ring-like arrangement, and the arrangement may be defined optionally. That is, a speaker array obtained by arranging a plurality of high-order speakers into any shape other than the ring-like shape can be used as the high-order speaker array 14. Consequently, in MD-LM, arrangement of the high-order speaker array 14 having a higher degree of freedom can be realized.

### <Explanation of Spatial Noise Cancelling Process>

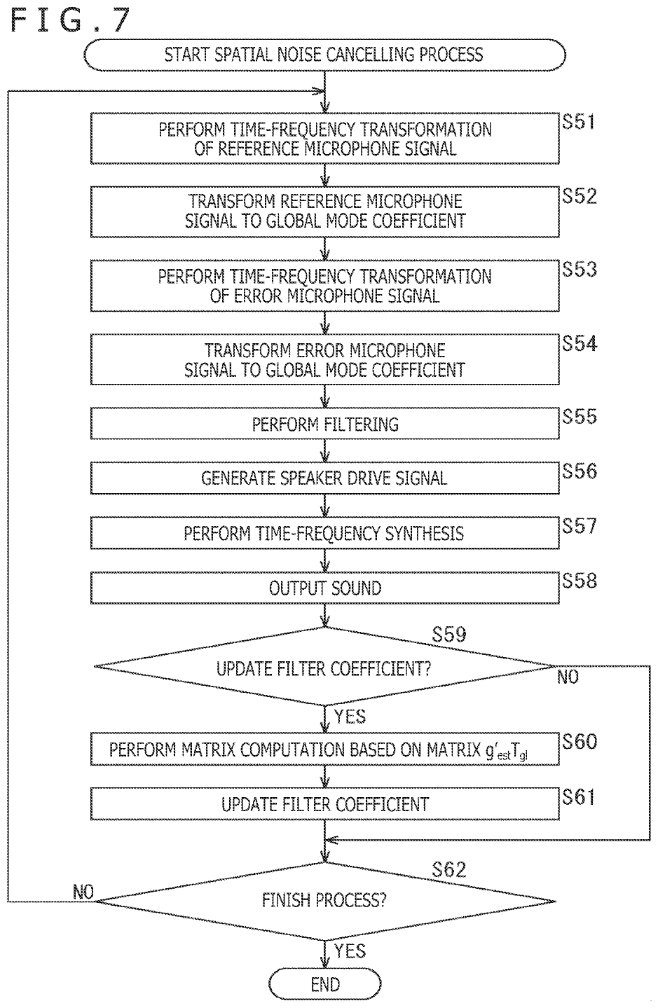

Next, operation of the MD-LM spatial noise cancelling system depicted in FIG. 6 will be explained. That is, a spatial noise cancelling process which is performed by the spatial noise cancelling system will be explained below with reference to a flowchart in FIG. 7.

It is to be noted that step S51 to step S54 are similar to step S11 to step S14 in FIG. 5, and thus, an explanation thereof is omitted.

In step S55, the filtering section 141 performs a filtering process on the basis of the global mode coefficient x′ supplied from the mode transformation section 81 and the filter coefficient w_{LM} supplied from the filter coefficient updating section 144.

Specifically, the filtering section 141 generates the abovementioned matrix X′ indicated by Expression (34) on the basis of the global mode coefficient x′ and obtains, as a speaker drive signal, a local mode coefficient by obtaining the product X′w_{LM} of the matrix X′ and the filter coefficient w_{LM}. The filtering section 141 supplies the speaker drive signal thus obtained to the drive signal generation section 142.

In step S56, the drive signal generation section 142 generates a frequency domain speaker drive signal on the basis of the speaker drive signal supplied from the filtering section 141 and the transformation matrix Tₛₗ and supplies the frequency domain speaker drive signal to the time-frequency synthesis section 24.

Specifically, the drive signal generation section 142 calculates a product TₛₗX′w_{LM} of the speaker drive signal X′w_{LM} and the transformation matrix Tₛₗ. The calculation result is a frequency domain speaker drive signal. When calculating (computing) the product TₛₗX′w_{LM}, computation to at least up to a term corresponding to a predetermined first or higher order radiation pattern of the high-order speaker is conducted.

After the frequency domain speaker drive signal is generated, step S57 and step S58 are performed. These steps are similar to step S17 and step S18 in FIG. 5, and thus, an explanation thereof is omitted.

In step S59, the control section 131 determines whether or not to update the filter coefficient w_{LM}.

It is determined, in step S59, not to update the filter coefficient w_{LM}, step S60 and step S61 are skipped. Then, the process proceeds to the step S62.

On the other hand, it is determined, in step S59, to update the filter coefficient w_{LM}, the process proceeds to step S60.

In step S60, the matrix computation section 143 conducts matrix computation on the global mode coefficient x′ supplied from the mode transformation section 81 on the basis of the held matrix g′ₑₛₜT_{gl}. Specifically, the matrix computation section 143 generates a matrix X′ on the basis of the global mode coefficient x′, obtains a product g′ₑₛₜT_{gl}X′ of the matrix X′ and the matrix g′ₑₛₜT_{gl}, and supplies the product g′ₑₛₜT_{gl}X′ to the filter coefficient updating section 144.

As with the abovementioned matrix computation at the matrix computation section 84, the matrix computation at the matrix computation section 143 is also computation in a wavenumber domain (mode domain). Thus, the computation amount can be reduced.

In step S61, the filter coefficient updating section 144 updates the filter coefficient w_{LM} on the basis of the product g′ₑₛₜT_{gl}X′ supplied from the matrix computation section 143, the current filter coefficient w_{LM}, and the global mode coefficient e′ supplied from the mode transformation section 85.

Specifically, the filter coefficient updating section 144 updates the filter coefficient w_{LM} by calculation similar to that of the abovementioned updating expression indicated by Expression (38) and supplies the updated filter coefficient w_{LM} to the filtering section 141. After the filter coefficient w_{LM} is updated, the process proceeds to step S62. In step S60 and step S61, the filter coefficient updating process is performed in terms of a wavenumber domain (mode domain), in the similar manner to that in MD-GM.

In a case where step S61 has been executed or it is determined, in step S59, not to update the filter coefficient w_{LM}, the control section 131 determines, in step S62, whether or not to finish the process.

In a case where it is determined, in step S62, not to finish the process, the process returns to step S51 to repeat the abovementioned steps.

On the other hand, in a case where it is determined, in step S62, to finish the process, operations that are being executed in the sections of the spatial noise cancelling system are stopped, whereby the spatial noise cancelling process is finished.

In the manner described so far, the spatial noise cancelling system outputs a sound from the high-order speaker array 14 while performing the filter coefficient updating process in terms of a wavenumber domain. As a result of this, the computation amount can be reduced, and further, since the high-order speaker array 14 is used, high-performance spatial noise cancelling can be performed with a saved space. That is, according to the MD-LM spatial noise cancelling system, high-performance spatial noise cancelling can be performed with a saved space and a small computation amount.

### <Comparison of Computation Amount>

As algorithms for spatial noise cancelling, MIMO, MD-GM, and MD-LM have been explained above. Next, computation amounts in MIMO, MD-GM, and MD-LM will be explained.

As previously explained, the processes during the spatial noise cancelling are classified into a filtering process and a filter coefficient updating process.

In the filtering process, since high speed and low delay are demanded, mounting using an FPGA (Field Programmable Gate Array) or DSP (Digital Signal Processor) board needs to be implemented. Meanwhile, an allowable delay in the filter coefficient updating process is larger than that in the filtering process, and thus, mounting using a general-purpose processor may also be adopted.

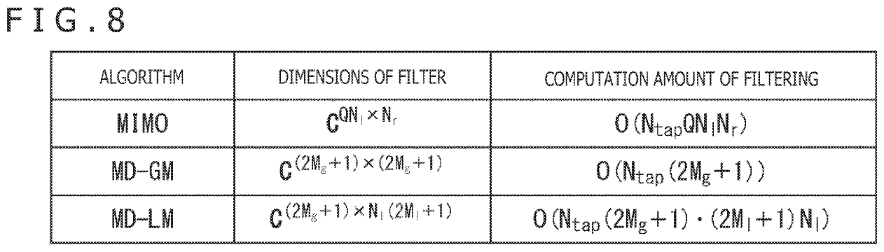

FIG. 8 depicts the shape (dimension) of a filter, and a computation amount per one sample required for a filtering process in MIMO, MD-GM, and MD-LM.

As depicted in FIG. 8, in MIMO, the dimension of a filter is QNₗ×Nᵣ, and the computation amount for the filtering process is O(NₜₐₚQNₗNᵣ). In MD-GM, the dimension of a filter is (2M_{g}+1)×(2M_{g}+1), and the computation amount for the filtering process is O(Nₜₐₚ(2M_{g}+1)). In MD-LM, the dimension of a filter is (2M_{g}+1)×Nₗ(2Mₗ+1), and the computation amount for the filtering process is O(Nₜₐₚ(2M_{g}+1)(2Mₗ+1)Nₗ). Nₜₐₚ represents a filter length.

Therefore, for example, when the filter length Nₜₐₚ=1024, the total number QNₗ of drivers of the high-order speaker array 14=192, the number Nᵣ of microphones of the reference microphone array 11=48, the global mode maximum order number M_{g}=14, the local mode maximum order number Mₗ=2, and the number Nₗ of high-order speakers of the high-order speaker array 14=12, the computation amounts in each mode are as follows.

That is, the computation amount O(NₜₐₚQNₗNᵣ) for the filtering process in MIMO is approximately 9.4×10⁶. On the other hand, the computation amount O(Nₜₐₚ(2M_{g}+1)) for the filtering process in MD-GM is approximately 3.0×10⁴, and the computation amount O(Nₜₐₚ(2M_{g}+1)(2Mₗ+1)Nₗ) for the filtering process in MD-LM is approximately 1.8×10⁶.

Accordingly, it can be seen that the computation amount for the filtering process in MD-GM is significantly reduced, compared to that in MIMO, and that the computation amount for the filtering process even in MD-LM, in which a filtering process is not performed in terms of a wavenumber domain, is reduced to approximately one-fifth of that in MIMO.

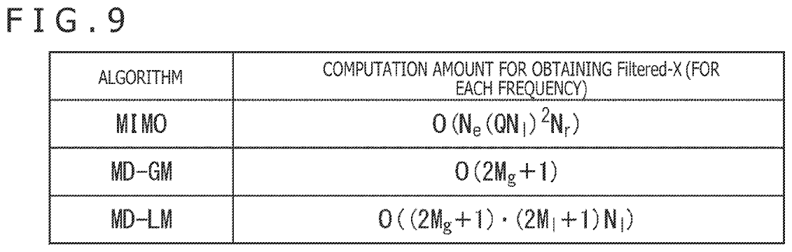

In addition, FIG. 9 depicts a computation amount (calculation amount) for each frequency, required for the filter coefficient updating process in MIMO, MD-GM, and MD-LM.

In the filter coefficient updating process, the computation amount to obtain Filtered-X, which is obtained by filtering, is the largest. Here, computation for obtaining GₑₛₜX in MIMO, computation for obtaining g′ₑₛₜX′ in MD-GM, and computation for obtaining g′ₑₛₜT_{gl}X′ in MD-LM each correspond to computation for obtaining Filtered-X.

As depicted in FIG. 9, the computation amount during calculation of Filtered-X is O(Nₑ(QNₗ)²Nᵣ) in MIMO, is O(2M_{g}+1) in MD-GM, and is O((2M_{g}+1)(2Mₗ+1)Nₗ) in MD-LM.

Therefore, when the total number QNₗ of drivers of the high-order speaker array 14=192, the number Nᵣ of microphones of the reference microphone array 11=48, the maximum order number M_{g}=14, the maximum order number Mₗ=2, the number N₁ of high-order speakers of the high-order speaker array 14=12, and the number Nₑ of microphones of the error microphone array 12=48, as in FIG. 8, for example, the computation amounts in the respective modes are as follows.

That is, the computation amount O(Nₑ(QNₗ)²Nᵣ) in MIMO is approximately 8.4×10⁷. On the other hand, the computation amount O(2M_{g}+1) in MD-GM is approximately 29. The computation amount O((2M_{g}+1)(2Mₗ+1)Nₗ) in MD-LM is approximately 1.7×10³.

Accordingly, it is understood that the computation amounts in MD-GM and MD-LM can be reduced significantly, compared to that in MIMO. In addition, from the viewpoint of computation amounts, MD-GM has an advantage over MD-LM. However, MD-LM has an advantage over MD-GM in that a second-order path can be obtained correctly to prevent deterioration in the performance of spatial noise cancelling, and that arrangement in the high-order speaker array 14 has a higher degree of freedom.

In addition, the convergence speed of the adaptive process, that is, the convergence speed of a filter coefficient in each of MD-GM and MD-LM is higher than that in MIMO. Thus, even when an environment such as the position of a listener in a target region is changed, the process quickly follows such a change, whereby high-performance spatial noise cancelling can be performed. In particular, the convergence speed of a filter coefficient in MD-GM is higher than that in MD-LM.

As explained so far, in MD-GM or MD-LM to which the present technology is applied, spatial noise cancelling that exhibits sufficient performance can be performed with a saved space and a small computation amount.

### Configuration Example of Computer

Meanwhile, the abovementioned series of processes can be executed by hardware or can be executed by software. In the case where the series of processes is executed by software, a program forming the software is installed into a computer. Here, examples of the computer include a computer incorporated in dedicated-hardware, and a general-purpose personal computer capable of executing various functions by installing various programs thereinto.

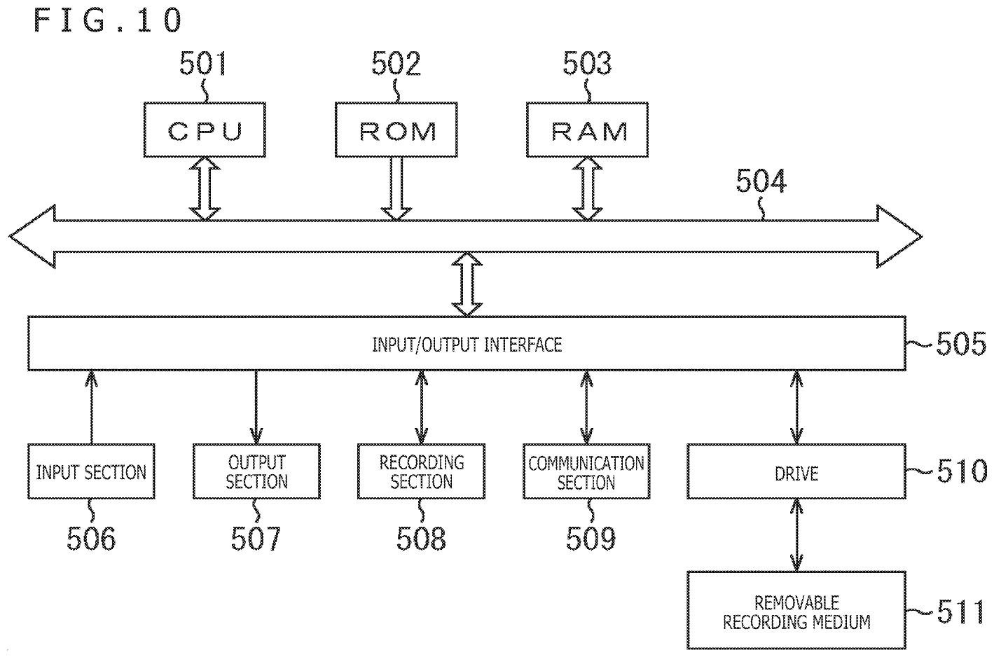

FIG. 10 is a block diagram depicting a hardware configuration example of a computer that executes the abovementioned series of processes in accordance with a program.

In the computer, a CPU 501, a ROM (Read Only Memory) 502, and a RAM (Random Access Memory) 503 are connected mutually via a bus 504.

An input/output interface 505 is additionally connected to the bus 504. An input section 506, an output section 507, a recording section 508, a communication section 509, and a drive 510 are connected to the input/output interface 505.

The input section 506 includes a keyboard, a mouse, a microphone, an imaging element, or the like. The output section 507 includes a display, a speaker, or the like. The recording section 508 includes a hard disk, a non-volatile memory, or the like. The communication section 509 includes a network interface or the like. The drive 510 drives a removable recording medium 511 which is a magnetic disk, an optical disk, a magneto-optical disk, a semiconductor memory, or the like.

In the computer thus configured, the CPU 501 loads a program recorded in the recording section 508, for example, into the RAM 503 via the input/output interface 505 and the bus 504 and executes the program. As a result, the abovementioned series of processes is executed.

The program to be executed by the computer (CPU 501) can be provided by being recorded in the removable recording medium 511 serving as a package medium, for example. Alternatively, the program can be provided via a wired or wireless transmission medium such as a local area network, the internet, or digital satellite broadcasting.

In the computer, when the removable recording medium 511 is mounted on the drive 510, the program can be installed into the recording section 508 via the input/output interface 505. Further, the program may be installed into the recording section 508 by being received by the communication section 509 via a wired or wireless transmission medium. Alternatively, the program may be installed in advance in the ROM 502 or the recording section 508.

It is to be noted that the program which is executed by the computer may be a program for executing the processes in the time-series order explained here or may be a program for executing the processes at a necessary timing such as a timing when a call is made.

In addition, the embodiments of the present technology are not limited to the abovementioned ones, and various changes can be made within the scope of the gist of the present technology.

For example, the present technology can be configured by cloud computing in which one function is shared and processed cooperatively by a plurality of devices over a network.

In addition, the steps having been explained with reference to the abovementioned flowcharts may be executed by one device or may be shared and executed by a plurality of devices.

Further, in a case where a plurality of processes is included in one step, the plurality of processes included in the one step may be executed by one device or may be shared and executed by a plurality of devices.

Further, the present technology may have the following configurations.

(1)

A signal processing device including:

a control section that generates, on the basis of a first microphone signal obtained by sound collection at a first microphone array, a speaker drive signal of an output sound for cancelling a sound which is propagated from an outside of a predetermined region to the predetermined region and is collected by the first microphone array, and that outputs the output sound from a speaker array on the basis of the speaker drive signal, the first microphone array including a plurality of microphones, the speaker array including at least one high-order speaker.

(2)

The signal processing device according to (1), in which

the control section includes
a filtering section that generates the speaker drive signal by performing, on the first microphone signal, a filtering process using a filter coefficient, and
a filter coefficient updating section that updates the filter coefficient on the basis of the first microphone signal.
   (3)

The signal processing device according to (2), in which

the filtering section generates the speaker drive signal for cancelling a sound which is propagated to the predetermined region, by point control.

(4)

The signal processing device according to (2), in which

the filtering section generates the speaker drive signal for cancelling a sound which is propagated to the predetermined region, by area control.

(5)

The signal processing device according to (4), in which

the filter coefficient updating section updates the filter coefficient in terms of a wavenumber domain.

(6)

The signal processing device according to (4) or (5), in which

the filtering section performs the filtering process in terms of a wavenumber domain.

(7)

The signal processing device according to any one of (4) to (6), in which

the control section generates the speaker drive signal by conducting computation of up to a term corresponding to a predetermined first or higher order radiation pattern of the high-order speaker.

(8)

The signal processing device according to (6), in which,

through the filtering process, the filtering section generates, as the speaker drive signal, a mode coefficient an origin of which is set at a predetermined reference position in a space.

(9)

The signal processing device according to (8), in which

the reference position is different from a position of the high-order speaker.

(10)

The signal processing device according to (4) or (5), in which,

through the filtering process, the filtering section generates, as the speaker drive signal, a mode coefficient an origin of which is set at a position of the high-order speaker and which is for the high-order speaker.

(11)

The signal processing device according to (10), in which

the speaker array is obtained by arranging a plurality of speakers including the high-order speaker into a shape other than a ring-like shape.

(12)

The signal processing device according to any one of (2) to (11), in which

the filter coefficient updating section updates the filter coefficient on the basis of the first microphone signal and a second microphone signal obtained by sound collection at a second microphone array that is disposed so as to be opposite to the first microphone array with respect to the speaker array, the second microphone array including a plurality of microphones.

(13)

A signal processing method including:

by a signal processing device,
generating, on the basis of a microphone signal obtained by sound collection at a microphone array including a plurality of microphones, a speaker drive signal of an output sound for cancelling a sound which is propagated from an outside of a predetermined region to the predetermined region and is collected by the microphone array; and
outputting, on the basis of the speaker drive signal, the output sound from a speaker array including at least one high-order speaker.
   (14)

A program for causing a computer to execute processing including the steps of:

generating, on the basis of a microphone signal obtained by sound collection at a microphone array including a plurality of microphones, a speaker drive signal of an output sound for cancelling a sound which is propagated from an outside of a predetermined region to the predetermined region and is collected by the microphone array; and

outputting, on the basis of the speaker drive signal, the output sound from a speaker array including at least one high-order speaker.

### REFERENCE SIGNS LIST

11: Reference microphone array
12: Error microphone array
14: High-order speaker array
61: Signal processing device
21: Time-frequency transformation section
22: Time-frequency transformation section
71: Control section
81: Mode transformation section
82: Filtering section
83: Drive signal generation section
84: Matrix computation section
85: Mode transformation section
86: Filter coefficient updating section
131: Control section

1. A signal processing device comprising:
a control section that generates, on a basis of a first microphone signal obtained by sound collection at a first microphone array, a speaker drive signal of an output sound for cancelling a sound which is propagated from an outside of a predetermined region to the predetermined region and is collected by the first microphone array, and that outputs the output sound from a speaker array on a basis of the speaker drive signal, the first microphone array including a plurality of microphones, the speaker array including at least one high-order speaker.

2. The signal processing device according to claim 1, wherein
the control section includes
a filtering section that generates the speaker drive signal by performing, on the first microphone signal, a filtering process using a filter coefficient, and
a filter coefficient updating section that updates the filter coefficient on the basis of the first microphone signal.

3. The signal processing device according to claim 2, wherein
the filtering section generates the speaker drive signal for cancelling a sound which is propagated to the predetermined region, by point control.

4. The signal processing device according to claim 2, wherein
the filtering section generates the speaker drive signal for cancelling a sound which is propagated to the predetermined region, by area control.

5. The signal processing device according to claim 4, wherein
the filter coefficient updating section updates the filter coefficient in terms of a wavenumber domain.

6. The signal processing device according to claim 4, wherein
the filtering section performs the filtering process in terms of a wavenumber domain.

7. The signal processing device according to claim 4, wherein
the control section generates the speaker drive signal by conducting computation of up to a term corresponding to a predetermined first or higher order radiation pattern of the high-order speaker.

8. The signal processing device according to claim 6, wherein,
through the filtering process, the filtering section generates, as the speaker drive signal, a mode coefficient an origin of which is set at a predetermined reference position in a space.

9. The signal processing device according to claim 8, wherein
the reference position is different from a position of the high-order speaker.

10. The signal processing device according to claim 4, wherein,
through the filtering process, the filtering section generates, as the speaker drive signal, a mode coefficient an origin of which is set at a position of the high-order speaker and which is for the high-order speaker.

11. The signal processing device according to claim 10, wherein
the speaker array is obtained by arranging a plurality of speakers including the high-order speaker into a shape other than a ring-like shape.

12. The signal processing device according to claim 2, wherein
the filter coefficient updating section updates the filter coefficient on a basis of the first microphone signal and a second microphone signal obtained by sound collection at a second microphone array that is disposed so as to be opposite to the first microphone array with respect to the speaker array, the second microphone array including a plurality of microphones.

13. A signal processing method comprising:
by a signal processing device,
generating, on a basis of a microphone signal obtained by sound collection at a microphone array including a plurality of microphones, a speaker drive signal of an output sound for cancelling a sound which is propagated from an outside of a predetermined region to the predetermined region and is collected by the microphone array; and
outputting, on a basis of the speaker drive signal, the output sound from a speaker array including at least one high-order speaker.

14. A program for causing a computer to execute processing comprising the steps of:
generating, on a basis of a microphone signal obtained by sound collection at a microphone array including a plurality of microphones, a speaker drive signal of an output sound for cancelling a sound which is propagated from an outside of a predetermined region to the predetermined region and is collected by the microphone array; and
outputting, on a basis of the speaker drive signal, the output sound from a speaker array including at least one high-order speaker.
